(19) United States
(12) Patent Application Publication
(10) Pub. No.: US 2011/0043621 A1
(43) Pub. Date: Feb. 24, 2011

(54) Image Processing Device And Image Processing Method

(75) Inventors: Kazuhiko Terada, Osaka (JP); Toshihiro Konaka, Osaka (JP)

Correspondence Address: KILYK & BOWERSOX, P.L.L.C., 400 HOLIDAY COURT, SUITE 102, WARRENTON, VA, 20186, US

(73) Assignee: KEYENCE CORPORATION, Osaka (JP)

(21) Appl. No.: 12/835,837

(22) Filed: Jul. 14, 2010

(30) Foreign Application Priority Data
Aug. 19, 2009 (JP) 2009-190548

(51) Int. Cl. H04N 7/18

(52) U.S. Cl. 348/135; 348/E07.085

(57) ABSTRACT

The invention aims to execute image processing in synchronization with predetermined procedures with a single controller and eliminate an image pickup inhibit period for preventing incomplete image pickup. Pickup completing conditions of a plurality of types that are established when the image data is obtained from a predetermined image pickup unit (one of a camera 30a to a camera 30c) are stored, and processing contents of the image pickup unit includes identifying whether or not the image data is obtained from the predetermined image pickup unit, determining whether or not any of the pickup completing conditions of the plurality of types is established, and executing an assignment process to the image data used for the execution of the measurement unit associated with the pickup completing condition that is determined to be established.

### CROSS REFERENCE TO RELATED APPLICATIONS

The present application claims foreign priority based on Japanese Patent Application No. 2009-190548, filed Aug. 19, 2009, the contents of which is incorporated herein by reference.

### BACKGROUND OF THE INVENTION

1. Field of the Invention

The present invention relates to an image processing device capable of picking up an image of a test object using an image pickup unit such as a camera and executing a measurement process using obtained image data and an image processing method.

2. Description of Related Art

In many of production sites such as factories, image processing devices with which an inspection process that have been relying on visual check by a person can be automated and speeded up are introduced. The image processing device typically uses a camera to pick up an image of a workpiece that is being carried on a conveyer belt or the like along a production line, and executes a measurement process such as edge detection and area calculation of a predetermined area based on the obtained image data. The image processing device then carries out an inspection such as crack detection and position detection of an alignment mark of the workpiece based on the processing results of the measurement process, thereby outputting a determination signal that determines the presence of a crack or position misalignment in the workpiece. In this manner, the image processing devices are often utilized as one type of factory automation sensors.

The image processing devices include a packaged type for which procedures to be executed are previously determined, and a type with which a desired measurement process is carried out by transferring an image processing program that executes desired procedures generated by a user using a personal computer (PC). With the former type, a degree of freedom of the image processing is limited since the image processing is carried out based only on the predetermined procedures. However, the latter type requires a highly enhanced programming skill and a large number of man-hours in order to carry out the desired measurement process. One example of the image processing devices that address to these problems presents a flowchart of a series of image processing procedures, and allows a user to change the procedures in the flowchart (see Japanese Unexamined Patent Publication No. H09-288568, for example). In order for the user to realize desired procedures, the procedures can be customized in the flowchart, for example, using special software running on the PC to generate an image processing program for causing the image processing device to execute the customized procedures, and the image processing program can be transferred to a controller of the image processing device.

An aspect of the image processing device with which the user can customize the procedures is specifically described with reference to FIG. 20. FIG. 20 is a diagram showing one example of a situation in which an image processing device is used. Referring to FIG. 20, an image of a workpiece 100 carried on a conveyer belt 200 is picked up using two cameras 301 and 302, and the measurement process is executed based on the obtained image data with a single controller 300 to which the camera 301 and the camera 302 are connected. FIG. 21 is a flowchart showing one example of the procedures generated by the user.

As shown in FIGS. 20 and 21, when the workpiece 100 is carried under the camera 301, the camera 301 picks up an image of the workpiece 100 based on a trigger input from an exterior (such as a photoelectric sensor, for example). Then, when the workpiece 100 is carried under the camera 302, the camera 302 picks up an image of the workpiece 100 based on a trigger input from an exterior (such as a photoelectric sensor, for example). In this manner, when the image pickup by the camera 301 and the camera 302 ends (step S101 in FIG. 21), the controller 300 executes the measurement process using two image data pieces obtained by the image pickup (step S102 in FIG. 21). In the flowchart shown in FIG. 21, a measurement cycle is determined by taking a flow sequence from a START symbol to an END symbol as a single cycle of the image processing.

Here, referring to FIG. 21, it is not possible to pick up an image of a workpiece that is carried after the workpiece 100 (a workpiece on the left side of the workpiece 100) by the camera 301 until the measurement process in step S102 ends. As described above, the flow sequence from the START symbol to the END symbol is a single cycle of the image processing, and consequently it is not possible to execute the pickup process in step S101 while the measurement process in step S102 is being executed. Further describing this point, in FIG. 21, the pickup process (step S101) immediately after the START symbol is first executed, and the images of the workpiece 100 are picked up. When the image data pieces that are required in the next measurement process (step S102) are obtained from the camera 301 and the camera 302, the image pickup in step S101 ends. Then, when the measurement process in step S102 is executed using the image data pieces obtained from the camera 301 and the camera 302 and the measurement process ends, a single cycle of the image processing (a single flow sequence) is completed. There are several advantages in executing each of the image processing (step S101 or step S102) in synchronization with the procedures shown in the flowchart. One example of such advantages is as follows. Executing each image processing asynchronously often causes a problem of memory contention due to more than one operations such as writing the image data that have been picked up to the memory and reading the image data from the memory to execute the measurement process are carried out at the same time. However, if each of the image processing is executed in synchronization with the procedures shown in the flowchart, such a problem of memory contention may not occur. Further, if each of the image processing is executed in synchronization with the procedures shown in the flowchart, it is possible to debug according to the procedures, thereby facilitating bug fix.

Due to the above reasons, in the image processing device with which the user is able to customize the procedures, each of the image processing is executed in synchronization with the predetermined procedures, and it is not possible to move onto the next processing step until a processing step that is currently executed ends. Accordingly, as described above, it is not possible to execute the pickup process in step S101 while the measurement process in step S102 is being executed in FIG. 21, and it is required to provide an image pickup inhibit period during which the image pickup by the camera 301 is disabled in order to prevent incomplete image pickup.

In this regard, there is a technique with which the image pickup by the camera 301 is internally enabled even while the measurement process in step S102 is being executed. As disclosed in, for example, Japanese Unexamined Patent Publication No. H10-32810, an image data memory for image pickup and an image data memory for measurement are provided and the image pickup is carried out along with the measurement process. By employing such a technique, in the flowchart shown in FIG. 21, it is possible to previously carry out the image pickup by the camera 301 for the next measurement cycle using the image data memory for image pickup, even if the measurement process in step S102 in which the image data memory for measurement is used has not been finished.

While the flowchart shown in FIG. 21 carries out a single image processing in the measurement process in step S102 using the image data piece obtained by the image pickup by the camera 301 and the image data piece obtained by the image pickup by the camera 302, there is a case in which it is desired to carry out the image processing separately for each image data piece.

FIG. 22 is a flowchart in which the separate image processing is carried out to each of the image data pieces respectively obtained by the image pickup by the camera 301 and by the camera 302. Referring to the flowchart shown in FIG. 22, first, when the workpiece 100 is carried under the camera 301, a first image pickup for obtaining an image data piece by the image pickup by the camera 301 is executed (step S201). After the first image pickup processing ends, a first measurement is executed to the obtained image data piece (step S202). Next, when the workpiece 100 is carried under the camera 302, a second image pickup for obtaining an image data piece by the image pickup by the camera 302 is executed (step S203). After the second image pickup ends, a second measurement is executed to the obtained image data piece (step S204).

Further, by employing the technique disclosed in Japanese Unexamined Patent Publication No. H10-32810 as described above, it is possible to internally carry out the image pickup by the camera 302 before the first measurement shown in step S202 ends, and before the second measurement in step S204 ends, it is possible to internally carry out the image pickup by the camera 301 in the next measurement cycle previously. As described above, by using the technique for carrying out the image pickup while the measurement process is being executed (that is, a technique for carrying out the measurement process and the pickup process asynchronously), it is possible to execute each of the image processing (step S201 to step S204) in synchronization with the procedures shown in the flowchart, as well as to prevent the incomplete image pickup.

### SUMMARY OF THE INVENTION

However, in the flowchart shown in FIG. 22, at least the image pickup by the camera 301 (the first image pickup in step S201) and the image pickup by the camera 302 (the second image pickup in step S203) are required to be processed in series. Specifically, it is not possible to execute the first image pickup in step S201 in the next measurement cycle when a workpiece subsequent to the workpiece 100 is carried under the camera 301 while the second image pickup shown in step S203 is being executed. This is because, as described with reference to FIG. 21, according to the image processing device in which each image processing is executed in synchronization with the procedures in the flowchart, it is not possible to move onto the next processing step (measurement cycle) until the currently executed processing step ends. Further, even if the technique disclosed in Japanese Unexamined Patent Publication No. H10-32810 is employed, a problem of memory contention occurs if an operation of writing the image data piece obtained by the first image pickup by the camera 301 to a memory and an operation of writing the image data piece obtained by the second image pickup by the camera 302 to a memory are carried out at the same time.

Accordingly, in the flowchart shown in FIG. 22, it is still necessary to provide an image pickup inhibit period during which the image pickup by the camera 301 is disabled in order to prevent incomplete image pickup from occurring. The presence of the image pickup inhibit period results in a delay in processing time of the camera 301, and consequently, resulting in inspection tact time delay.

Therefore, it is conceivable to provide two controllers 300 as shown in FIG. 20, for example, and separate the image pickup by the camera 301 and the image pickup by the camera 302. Specifically, the camera 301 is connected to one of the two controllers, and the camera 302 is connected to the other controller. As shown in FIGS. 23A and 23B, this is equivalent to providing two independent flowcharts as the procedures. FIG. 23A shows procedures in which the first image pickup for obtaining the image data piece by the camera 301 (step S201) and the first measurement using the obtained image data piece (step S202) are connected in series, and FIG. 23B shows procedures in which the second image pickup for obtaining the image data piece by the camera 302 (step S203) and the second measurement using the obtained image data piece (step S204) are connected in series.

Referring to FIGS. 23A and 23B, as the image pickup by the camera 301 with the one controller (the first image pickup in step S201) and the image pickup by the camera 302 with the other controller (the second image pickup in step S203) can be independently provided, the first image pickup in step S201 can be executed even when the workpiece subsequent to the workpiece 100 is carried under the camera 301 while the second image pickup by the camera 302 is being executed (step S203).

However, in order to realize the image processing as shown in the flowcharts of FIGS. 23A and 23B, the two controllers are required as described above, and this imposes an unnecessary cost on the user. Accordingly, it is conceivable to realize the image processing by the flowcharts shown in FIGS. 23A and 23B only with a single controller. However, if the two flow sequences of the image processing shown in the flowchart of FIG. 23A and the image processing shown in the flowchart of FIG. 23B are executed asynchronously similarly to the case using the two controllers, it is not possible to provide advantageous effects that can be obtained by executing each image processing in synchronization with the procedures shown in the flowchart, as the problem of memory contention can occur or it may not be possible to debug along one of the flow sequences, as described above.

As described above, according to the conventional image processing device, when attempting to eliminate the image pickup inhibit period for preventing the incomplete image pickup only with a single controller in order to improve an inspection tact and to prevent the user from being imposed with an unnecessary cost, there has been a problem that it is not possible to provide advantageous effects (preventing the memory contention and facilitating the bug fix) that can be obtained by executing each image processing in synchronization with predetermined procedures as described with reference to FIGS. 23A and 23B.

The present invention has been made in view of the above problems, and an object of the present invention is to provide an image processing device and an image processing method capable of executing each image processing in synchronization with predetermined procedures with a single controller and eliminating an image pickup inhibit period for preventing incomplete image pickup at the same time.

An image processing device according to the present invention is provided with a plurality of cameras that generate image data by picking up images of a test object, and configured to carry out measurement using the image data obtained from the plurality of cameras, output a determination signal by determining whether the test object is good or defective based on a result of the measurement, and execute an assignment process of carrying out assignment of the image data obtained from the plurality of cameras to be used in the measurement and a plurality of measurement processes of carrying out the measurement using the image data assigned in the assignment process, and the image processing device includes: a setting unit that sets a plurality of patterns of association between a type or types of one or more of the plurality of cameras and one of the plurality of measurement processes; a determining unit that identifies a camera from which the image data is obtained out of the plurality of cameras, and determines whether or not the image data is obtained from a camera specified by one of the plurality of patterns of association set by the setting unit; and an assigning unit that carries out assignment for executing one of the measurement processes that is specified by the pattern of association for which the image data is determined to have been obtained.

According to such a configuration, for example, by transferring an image processing program from an external program generation assisting device, the plurality of patterns of association are set between the type or the types of one or more of the plurality of cameras and one of the plurality of measurement processes, it is determined whether or not the image data is obtained from the camera specified by one of the plurality of patterns of association, and the assignment for executing one of the measurement processes that is specified by the pattern of association for which the image data is determined to have been obtained is carried out. Therefore, it is possible to execute each process in synchronization with the predetermined procedures including the image pickup by the camera and the assignment process for using in the measurement, and the measurement process using the image data. Further, the assignment process as used in the present invention is carried out by being triggered by the image data being obtained from the camera specified by one of the plurality of patterns of association set by the setting unit, and it is possible to operate an image pickup mechanism that obtains the image data from the plurality of cameras that pick up images of the test object asynchronously with the predetermined procedures described above. As a result, it is possible to eliminate an image pickup inhibit period that is provided to prevent incomplete image pickup. Further, it is possible to realize such an effect only with a single controller.

In this case, the image processing device may be configured such that, when the determining unit determines that the image data is not obtained, the assigning unit stands by without carrying out the assignment for executing the measurement process.

According to such a configuration, the assigning unit stands by without carrying out the assignment for executing the measurement process when the determining unit determines that the image data is not obtained. Therefore, even in such a case, an assignment error in which the assignment by the assigning unit cannot be carried out may not occur, and it is possible to execute the assignment process and the one measurement process in synchronization with the predetermined procedures.

Moreover, the image processing device may be configured such that, when the image data is determined to have been obtained from a camera of the type specified by two or more of the plurality of patterns of association set by the setting unit, the assigning unit carries out the assignment for executing the measurement process specified by one of the patterns of association based on predetermined priority.

According to such a configuration, when the image data is determined to have been obtained from the camera of the type specified by two or more of the plurality of patterns of association set by the setting unit, the assigning unit carries out the assignment for executing the measurement process specified by one of the patterns of association based on predetermined priority. Therefore, even in such a case, it is possible to avoid the situation in which the target of the assignment by the assigning unit is unknown (that is, even when the image data is determined to have been obtained from a camera of the type specified by two or more patterns of association, it is possible to specify the pattern of association that specifies the measurement process for which the assignment is to be executed). Accordingly, it is possible to execute the assignment process and the one measurement process in synchronization with the predetermined procedures.

Moreover, the image processing device may be configured such that the priority is determined based on a timing at which the image data is obtained by the camera of the type specified by one of the plurality of patterns of association that have been set by the setting unit.

According to such a configuration, as the assignment can be carried out based on the timing at which the image data is obtained from the camera is fast or late, it is possible to carry out the assignment in consideration with the order in which the image data is obtained from the camera (on the so-called first-come-first-served basis).

Further, in an image processing method using an image processing device provided with a plurality of cameras that generate image data by picking up images of a test object, and configured to carry out measurement using the image data obtained from the plurality of cameras, output a determination signal by determining whether the test object is good or defective based on a result of the measurement, and execute an assignment process of carrying out assignment of the image data obtained from the plurality of cameras to be used in the measurement and a plurality of measurement processes of carrying out the measurement using the image data assigned in the assignment process, the image processing method may include: a setting step of setting a plurality of patterns of association between a type or types of one or more of the plurality of cameras and one of the plurality of measurement processes; a determining step of identifying a camera from which the image data is obtained out of the plurality of cameras, and determines whether or not the image data is obtained from a camera specified by one of the plurality of patterns of association set by the setting step; and an assigning step of carrying out assignment for executing one of the measurement processes that is specified by the pattern of association for which the image data is determined to have been obtained.

According to such a method, similarly to the image processing device described above, it is possible to execute the assignment process and the measurement process in synchronization with the predetermined procedures with a single controller, as well as to operate the image pickup mechanism asynchronously with the predetermined procedures, thereby eliminating an image pickup inhibit period that is provided to prevent incomplete image pickup.

As described above, according to the present invention, as the assignment process and the measurement process can be executed in synchronization with the predetermined procedures, it is possible to prevent problems of memory contention and bug fix that are caused when the above processes are asynchronously executed.

Further, according to the present invention, as it is possible to operate the image pickup mechanism that obtains the image data from the plurality of image pickup units that pick up images of the test object asynchronously with the predetermined procedures, an image pickup inhibit period that is provided to prevent incomplete image pickup can be eliminated. Further, it is possible to realize these effects only with a single controller.

### BRIEF DESCRIPTION OF THE DRAWINGS

FIG. 1 is a diagram showing a schematic configuration of an image processing device according to an embodiment of the present invention;

FIGS. 2A and 2B are flowcharts for schematically describing an operation of the image processing device;

FIG. 3 is a block diagram showing a hardware configuration of the image processing device according to the embodiment of the present invention;

FIG. 4 is a flowchart showing an operation of an image pickup mechanism in the image processing device according to the present embodiment;

FIG. 5 is a flowchart showing a flow of image processing of the image processing device according to the present embodiment;

FIG. 6 is a flowchart showing a detailed flow of an image pickup unit process shown in FIG. 5;

FIG. 7 is a diagram showing one example of pickup completing conditions that are previously set;

FIG. 8 shows a timing chart (conceptual diagram) showing the flow of the image processing of the image processing device according to the present embodiment;

FIG. 9 is a block diagram showing an example of a functional configuration of a PC that generates an image processing program of the image processing device;

FIG. 10 is a diagram showing one example of an editor screen (only a main portion) displayed in a display section of the PC;

FIG. 11 is a diagram showing one example of a setting screen for setting the pickup completing conditions shown in FIG. 7;

FIG. 12 shows a timing chart (conceptual diagram) showing the flow of the image processing of the image processing device according to another embodiment of the present invention;

FIG. 13 is a pickup completing condition setting table used by the image processing device according to another embodiment of the present invention;

FIG. 14 is a pickup completing condition setting table used by the image processing device according to another embodiment of the present invention;

FIG. 15 shows a timing chart (conceptual diagram) showing a flow of the image processing using the pickup completing condition setting table shown in FIG. 14;

FIG. 16 is a pickup completing condition setting table used by the image processing device according to another embodiment of the present invention;

FIG. 17 is a flowchart showing a flow of the image processing of the image processing device according to another embodiment of the present invention;

FIG. 18 is a pickup completing condition setting table used by the image processing device according to another embodiment of the present invention;

FIG. 19 is a flowchart showing a flow of the image processing of the image processing device according to another embodiment of the present invention;

FIG. 20 is a diagram showing how an image of a workpiece carried on a conveyer belt is picked up using two cameras;

FIG. 21 is a flowchart showing a flow of the conventional image processing when inspecting a workpiece;

FIG. 22 is a flowchart showing a flow of the conventional image processing when inspecting a workpiece; and

FIGS. 23A and 23B are flowcharts showing a flow of the conventional image processing when inspecting a workpiece.

### DESCRIPTION OF THE PREFERRED EMBODIMENTS

Hereinafter, an image processing device according to embodiments of the present invention will be specifically described with reference to the drawings.

### Schematic Configuration

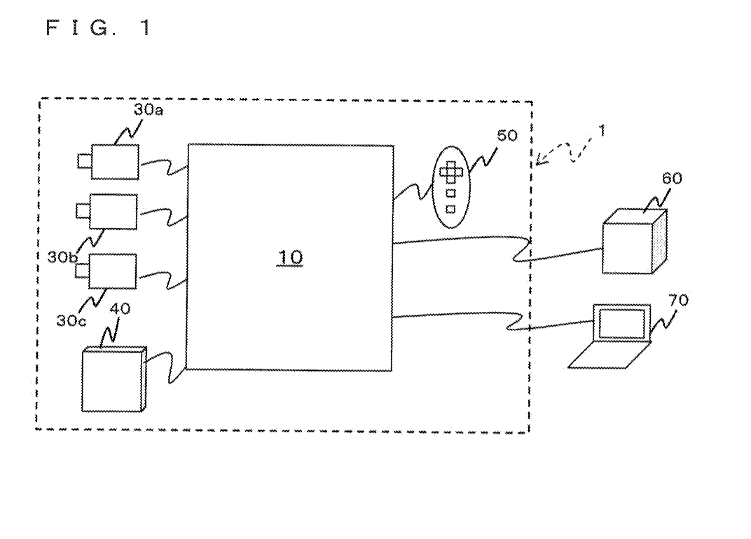

FIG. 1 is a diagram showing a schematic configuration example of an image processing device 1 according to an embodiment of the present invention. Referring to FIG. 1, the image processing device 1 is provided with a controller 10 that executes a measurement process such as edge detection and area calculation, three cameras 30a, 30b, and 30c that respectively pick up images of a test object, a monitor 40 such as a liquid crystal panel, and a console 50 with which a user carries out various operations on the monitor 40. The cameras 30a, 30b, and 30c, the monitor 40, and the console 50 are detachably connected to the controller 10. The controller 10 executes the measurement process using image data obtained from the cameras 30a, 30b, and 30c, and outputs a determination signal to a PLC 60, the determination signal indicating a determination result of a workpiece such as good or defective.

Each of the three cameras 30a, 30b, and 30c picks up an image of the test object based on a control signal inputted from the PLC 60, that is, an image pickup trigger signal, that specifies a timing at which the image data is captured by each of the cameras 30a, 30b, and 30c. The monitor 40 is a display device that displays the image data that has been obtained by picking up the image of the test object or results of the measurement process using the image data. In general, the user visually observes the monitor 40, to check an operational state of the controller 10 when the image processing device 1 is in operation. The console 50 is an input device for moving a focus position over the monitor 40 or selecting a menu item.

Further, the controller 10 of the image processing device 1 is connected with a PC 70 that generates an image processing program (control program) for the image processing device 1, and an image processing program that specifies procedures of image processing units is generated based on software operating on the PC 70 (details will be described later). In the image processing device 1, each image processing unit is sequentially executed according to the procedures. The PC 70 and the controller 10 are connected via a communication network, and the image processing program generated on the PC 70 is transferred to the controller 10 along with layout information that specifies a display mode of the monitor 40. On the other hand, the image processing program or the layout information can be imported from the controller 10 and edited with the PC 70.

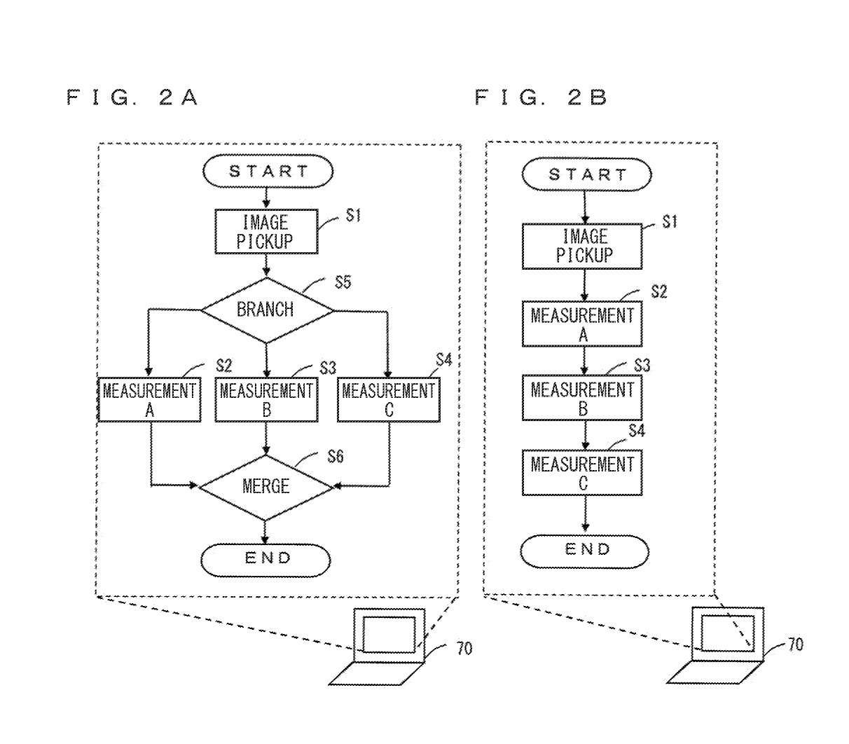

FIGS. 2A and 2B are flowcharts for schematically describing an operation of the image processing device 1. Referring to FIGS. 2A and 2B, measurement A in step S2 represents a measurement unit that executes a predetermined measurement process using the image data obtained by image pickup by the camera 30a, measurement B in step S3 represents a measurement unit that executes a predetermined measurement process using the image data obtained by image pickup by the camera 30b, and measurement C in step S4 represents a measurement unit that executes a predetermined measurement process using the image data obtained by image pickup by the camera 30c. Further, these measurement units are stored in the controller 10 along with the image pickup unit in step S1, a branch unit in step S5 (FIG. 2A), and a merge unit in step S6 (FIG. 2A), as a plurality of image processing units whose processing contents to be executed are specified. Moreover, the flowcharts shown in FIGS. 2A and 2B are generated by the user using, for example, the software operating on the PC 70 shown in FIG. 1, and represent the procedures of the image processing unit.

Here, an image pickup unit (step S1) in the image processing device 1 according to the present embodiment executes an assignment process to the image data obtained from the cameras 30a, 30b, and 30c for using the image data in the measurement process executed by the measurement unit. Further, it is determined whether or not pickup completing conditions of a plurality of types (details will be described later) that can be established when the image data is obtained from a predetermined camera out of the cameras 30a, 30b, and 30c are established when executing the assignment process, and the assignment process is executed to the image data used for the execution of the measurement unit that is associated with the pickup completing condition that is determined to be established.

In FIGS. 2A and 2B, a condition A is established as a pickup completing condition when the image data from the camera 30a is obtained, a condition B is established as a pickup completing condition when the image data from the camera 30b is obtained, and a condition C is established as a pickup completing condition when the image data from the camera 30c is obtained.

Further, the condition A is associated with the measurement A, the condition B is associated with the measurement B, and the condition C is associated with the measurement C. Specifically, such association is made in properties of the branch unit in step S5 of FIG. 2A, and in properties of each measurement unit of FIG. 2B.

Describing the flowchart shown in FIG. 2A in detail, first, the image pickup unit (step S1) located immediately under the START symbol is executed. Specifically, the controller 10 includes an image pickup mechanism that can be operated asynchronously with the flowchart shown in FIG. 2A, and is able to obtain the image data obtained from the image pickup by the cameras 30a, 30b, and 30c with the image pickup mechanism independently from the flowchart shown in FIG. 2A. The controller 10 further includes a function for identifying the camera from which the image data is obtained, and determines whether the conditions A to C are established based on a result of the identification. If it is determined that any of the conditions is not established, the controller 10 stands by while exerting the above identification function until any of the conditions A to C is established. Regarding a timing for identifying the camera from which the image data is obtained (timing for accessing the memory, for example), the identification can be carried out continuously or periodically.

When the image data obtained by the image pickup by the camera 30a is obtained, for example, the controller 10 determines that the condition A is established, and the assignment process is executed to the image data as the image data used for the execution of the measurement unit (the measurement A) associated with the condition A. By executing the assignment process, the image data is recognized as an object to which the measurement A is to be executed.

After the assignment process, the execution of the image pickup unit (step S1) ends and the process moves onto the execution of the branch unit (step S2). In this branch unit, a branching process for causing the flowchart to branch into the measurement units (the measurement A to the measurement C) is executed. At this time, as the condition A is associated with the measurement A as described above, the process moves to the measurement unit in step S2 (the measurement A) after the branch unit. Then, using the image data obtained by the image pickup by the camera 30a, the measurement process indicated by the measurement A is executed. After the measurement process, the single flow sequence is completed at the END symbol after a merge unit in step S6.

The same applies to the case in which the controller 10 obtains the image data obtained by the image pickup by the camera 30b, and to the case in which the controller 10 obtains the image data obtained by the image pickup by the camera 30c. That is, in the former case, the measurement unit in step S3 (the measurement B) is executed after the image pickup unit in step S1 via the branch unit in step S5, and, in the latter case, the measurement unit in step S4 (the measurement C) is executed after the image pickup unit in step S1 via the branch unit in step S5.

Conventionally, a timing at which the execution of the image pickup unit (step S1) ends is simply determined at such a timing when the assignment process is executed to the image data used for executing the measurement A, and therefore it is not possible to realize the flow sequence as shown in FIG. 2A. That is, when the timing at which execution of the image pickup unit ends is determined to be the timing at which the assignment process is executed to the image data used for executing the measurement A, the image processing is carried out only through a process flow in which the measurement unit (the measurement A) in step S2 is carried out after the image pickup unit in step S1 via the branch unit in step S5. Further, when the timing at which the execution of the image pickup unit ends is determined to be the timing at which the assignment process is executed to the image data used for executing the measurement B, the image processing is carried out only through a process flow in which the measurement unit (the measurement B) in step S3 is carried out after the image pickup unit in step S1 via the branch unit in step S5. Similarly, when the timing at which the execution of the image pickup unit ends is determined to be the timing at which at which the assignment process is executed to the image data used for executing the measurement C, the image processing is carried out only through a process flow in which the measurement unit (the measurement C) in step S4 is carried out after the image pickup unit in step S1 via the branch unit in step S5.

However, as in the image processing device 1 according to the present embodiment, by setting the timing at which the execution of the image pickup unit (step S1) ends to be the timing at which the assignment process is executed to the image data that is used for executing the measurement unit (one of the measurement A to the measurement C) associated with the pickup completing condition which is one of the pickup completing conditions of the plurality of types that is determined to be established, it is possible to realize the process flow as shown in FIG. 2A.

Next, the flowchart shown in FIG. 2B is described. The flowchart shown in FIG. 2B does not include the branch unit (step S5) and the merge unit (step S6) that are included in the flowchart shown in FIG. 2A. In FIG. 2B, as described above, the association between the pickup completing condition and the measurement unit is made in the properties of each measurement unit. Therefore, the measurement unit (the measurement A) in step S2 is executed when it is determined that the condition A is established, but skipped without being executed otherwise. Further, the measurement unit (the measurement B) in step S3 is executed when it is determined that the condition B is established, but skipped without being executed otherwise. Moreover, the measurement unit (the measurement C) in step S4 is executed when it is determined that the condition C is established, but skipped without being executed otherwise. It should be noted that the processing content of the image pickup unit (step S1) is the same as in FIG. 2A.

Therefore, when the assignment process is executed after it is determined that the condition A is established in the image pickup unit (step S1), only the measurement unit (the measurement A) in step S2 is executed as the subsequent process flow, and the measurement unit (the measurement B) in step S3 and the measurement unit (the measurement C) in step S4 are skipped, and the single flow sequence ends at the END symbol. The same also applies to the case in which the assignment process is executed after it is determined that the condition B or the condition C is established.

In FIGS. 2A and 2B, the pickup completing condition is determined to be established when the image data “have been obtained” from the cameras 30a to 30c in the controller 10. However, the pickup completing condition can be determined to be established when the image data “is being obtained” from the cameras 30a to 30c. Specifically, for example, the pickup completing condition can be determined to be established when the image pickup trigger signal of any of the cameras 30a to 30c is inputted from the PLC 60 to the controller 10.

As described above, the image processing device 1 stores the plurality of image processing units in which the processing contents to be executed are specified, and the image processing units include the measurement units (step S2 to step S4) that execute the measurement process using the image data obtained from the camera that pick ups the image of the test object, and the image pickup unit (step S1) that executes the assignment process to the image data obtained from the camera for using the image data in the measurement process. Further, based on the image processing program that specifies the procedures of image processing unit, the image processing device 1 sequentially executes the image processing units according to the procedures.

Moreover, the image processing device 1 stores the pickup completing conditions of the plurality of types that are established when the image data is obtained from the predetermined camera out of the plurality of cameras. Specifically, there are set a plurality of patterns of association between one or a plurality of types of cameras (such as the cameras 30a, 30b, and 30c) and one of the plurality of measurement processes (step S2 to step S4). Further, the processing content of the image pickup unit (step S1) includes identifying the camera from which the image data is obtained out of the plurality of cameras, determining whether or not any of the pickup completing conditions of the plurality of types is established, carrying out the assignment to the image data used for the execution of the measurement unit associated with the pickup completing condition that is determined to be established (that is, when it is determined that the image data is obtained from the camera of the type specified in one association pattern out of the plurality of patterns of association, one measurement process specified in the one association pattern).

In this manner, it is possible to execute the image pickup unit and the measurement unit in synchronization with the predetermined procedures such that the process moves from the one image pickup unit to the measurement unit associated with the pickup completing condition that is determined to be established out of the measurement units included in the procedures. In addition, in the image pickup unit according to the present invention, the movement to the measurement unit is triggered by the determination that any of the pickup completing conditions of the plurality of types is established. Accordingly, it is possible to cause the image pickup mechanism that obtains the image data from the plurality of image pickup units that pick up the images of the test object to operate asynchronously with the predetermined procedures. As a result, it is possible to eliminate the image pickup inhibit period for preventing the incomplete image pickup. In addition, it is possible to realize such an effect only with a single controller.

The present embodiment described below takes an example in which the association between the pickup completing conditions and the measurement units is made in the properties in the branch unit (step S5) as shown in FIG. 2A.

### Hardware Configuration

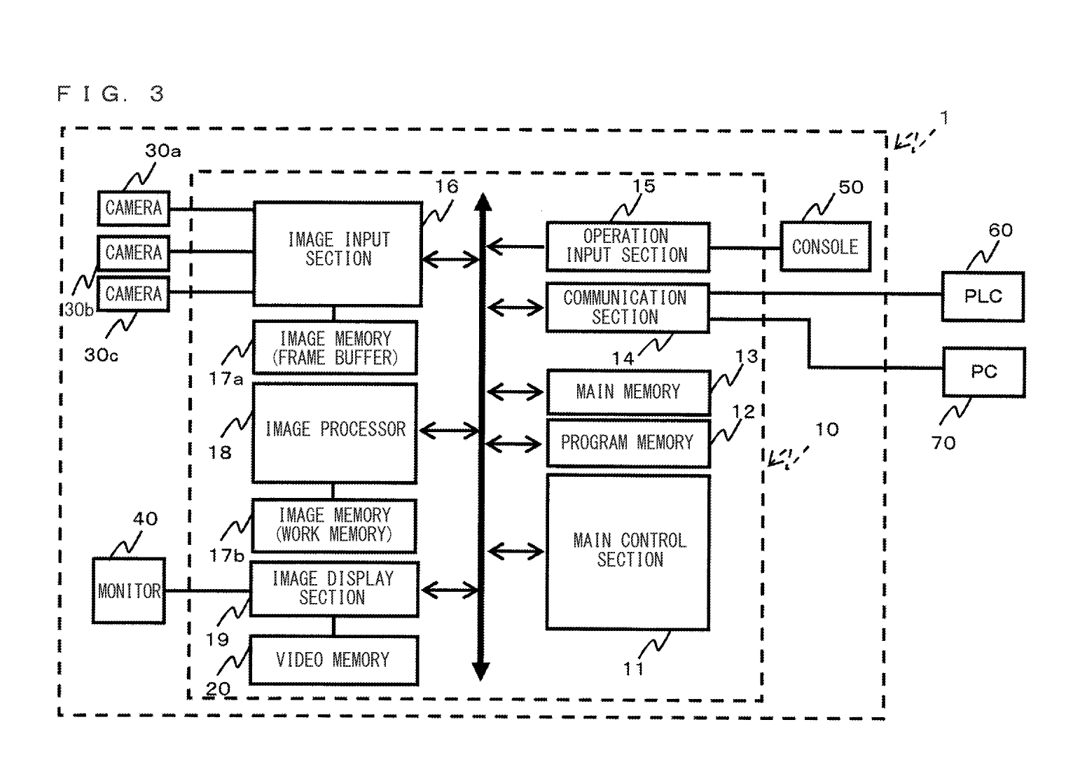

FIG. 3 is a block diagram showing a hardware configuration of the controller 10 in the image processing device 1 according to the present embodiment. Referring to FIG. 3, the controller 10 in the image processing device 1 is provided with a main control section 11 such as a CPU that carries out numeric calculation or information processing based on various programs as well as controls the hardware components, a program memory 12 such as a ROM or a flash ROM that stores programs such as a boot program and an initialization program, a main memory 13 such as a RAM functioning as a work area when the CPU 11 executes various programs, a communication section 14 that is externally connected to the PLC 60, the PC 70, or the like so as to be able to communicate to each other, and an operation input section 15 to which an operation signal from the console 50 is inputted. Further, the image processing device 1 is provided with an image input section 16 such as an ASIC that captures image data obtained by the image pickup by the cameras 30a to 30c, an image memory (frame buffer) 17a that buffers the image data, an image processor 18 such as a DSP that executes the measurement process such as edge detection and area calculation, an image memory (work memory) 17b that stores the image data for the measurement process, an image display section 19 such as a DSP that displays an image in the monitor 40 such as a liquid crystal panel, and a video memory 20 such as a VRAM that temporarily stores the image data when displaying the image. Further, these hardware components are connected so as to be able to communicate to each other via electric wiring such as a bus.

The program memory 12 stores a device control program for causing the image input section 16, the image processor 18, the image display section 19, and the communication section 14 and the operation input section 15 to be controlled by the main control section 11. Further, a program memory (not shown) in the image input section 16 stores an image input program for executing various processes such as capturing of the image data obtained by the image pickup by the cameras 30a to 30c, buffering to the image memory 17a, the assignment process of the buffered image data for the measurement process, and internally transferring to the image memory 17b. A program memory (not shown) in the image processor 18 stores a measurement process program for executing the measurement process. A program memory (not shown) in the image display section 19 stores an image display program for displaying an image on the monitor 40. Alternatively, the image input program, the measurement process program, and the image display program can be stored in the program memory 12 or the main memory 13 described above.

The main memory 13, the image memories 17a and 17b, and the video memory 20 are configured by volatile memories such as SRAMs or SDRAMs, and respectively provided as independent memories in the controller 10 shown in FIG. 3. These memories can be configured by nonvolatile memories, or by a single memory divided into a plurality of memory areas that constitute the respective memories. Further, the image memory 17a as the frame buffer is configured to be simultaneously accessible both in reading and writing.

The communication section 14 functions as an interface (I/F) to receive the image pickup trigger signal from the PLC 60, when a trigger input is made to a sensor (such as a photoelectric sensor) connected to the external PLC 60. Further, the communication section 14 also functions as an interface (I/F) to receive the image processing program of the image processing device 1 or the layout information that specifies the display mode of the monitor 40 that are transferred from the PC 70. The main control section 11 transmits a pickup command to the image input section 16 upon reception of the image pickup trigger signal from the PLC 60 via the communication section 14. The image pickup trigger signal can be an image pickup trigger to one of the cameras 30a to 30c, or can be image pickup triggers to all of the cameras 30a to 30c. Consequently, the pickup command transmitted from the main control section 11 to the image input section 16 can also be a pickup command for one of the cameras 30a to 30c, or can be a pickup command for all of the cameras 30a to 30c at the same time. In addition, a sensor such as a photoelectric sensor for inputting a trigger can be directly connected to the communication section 14 as a device that generates an image pickup trigger signal, instead of the PLC 60.

The operation input section 15 functions as an interface (I/F) to receive an operation signal from the console 50. The console 50 is provided with an arrow key for moving a cursor on the monitor 40 right to left or up and down, a determination button, and a cancellation button. These components can be used when the user sets the pickup completing conditions or the like. The console 50 can be replaced by a keyboard or a mouse. Further, it is possible to use a touch panel into which the function of the console 50 and the function of the monitor 40 are integrated.

The cameras 30a to 30c is one example of an image pickup unit that uses visible light or infrared light to pick up the image of the test object, and can be a CCD or a CMOS. The three cameras 30a to 30c connected to the image input section 16 are respectively provided with A/D converters therein, and output the image data obtained by the image pickup as digital data. Further, each camera operates based on an image data capturing signal from the image input section 16 (or the main control section 11). For example, it is possible to pick up the image of the test object by only one of the cameras 30a to 30c, or by all of the cameras 30a to 30c. It is also possible to provide an amplifier such as a repeater between the cameras 30a to 30c and the image input section 16. Further, the cameras 30a to 30c are provided with the A/D converters in the present embodiment, but it is possible to use a camera with an analog output and provide an A/D converter for the image input section 16. Moreover, the three cameras are connected to the image input section 16 in the present embodiment, but it is possible to connect four cameras to the image input section 16, for example.

The image input section 16 captures the image data according to the image input program described above. Specifically, for example, upon reception of the pickup command for the camera 30a from the main control section 11, the image input section 16 transmits the image data capturing signal to the camera 30a. Then, after the image pickup by the camera 30a, the image input section 16 captures the image data obtained by the image pickup. The captured image data is temporarily buffered in the image memory 17a.

Here, in the image processing device 1 according to the present embodiment, the pickup command that is transmitted from the main control section 11 to the image input section 16 is temporarily cached in a work memory (not shown) within the image input section 16. Accordingly, the image input section 16 refers to the content of the pickup command cached in work memory, thereby identifying the camera out of the cameras 30a to 30c from which the image data buffered in the image memory 17a is obtained. On the other hand, the main memory 13 stores the pickup completing conditions of the plurality of types that are established when the image data is obtained from the predetermined camera out of the cameras 30a to 30c (details will be described later).

The image input section 16 identifies the camera out of the cameras 30a to 30c from which the image data buffered in the image memory 17a is obtained by referring to the content of the cached pickup command, accesses the main memory 13 to refer to the pickup completing conditions of the plurality of types, and determines which pickup completing condition out of the pickup completing conditions of the plurality of types is established.

When it is determined that one pickup completing condition is established out of the pickup completing conditions of the plurality of types, the image input section 16 executes the assignment process for the measurement process (assignment process) to the image data stored in the image memory 17a, as the image data used for the execution of the measurement unit associated with the one pickup completing condition. Specifically, in the image memory 17a, the image data is substituted with an image variable that is previously prepared. Unlike normal variable that handles numeric numbers, by assigning as an input image of the corresponding image processing unit (details of the image processing unit will be described later), the image variable is a variable which becomes a target of reference in the measurement process or image display. By substituting the image data with the image variable by the image input section 16 and executing the assignment process for the measurement process, the execution of the image pickup unit is completed as described with reference to FIGS. 2A and 2B.

Further, when it is determined that the plurality of pickup completing conditions out of the pickup completing conditions of the plurality of types are established, the image input section 16 executes the assignment process for the measurement process to the image data that is used for the execution of the measurement unit associated with one pickup completing condition based on priority that is previously specified. Details of the “previously specified priority” will be described later.

On the other hand, when it is determined that any of the pickup completing conditions of the plurality of types is not established, the image input section 16 does not execute the assignment process for the measurement process, and continues the process of identifying the camera from which the image data is obtained out of the cameras 30a to 30c. The process of identification can be repeated continuously or periodically, and how the process is repeated is not particularly limited.

When the execution of the measurement unit starts, the image input section 16 reads the image data from the image memory 17a, and internally transfers the image data to the image memory 17b through the image processor 18. Then, the image processor 18 executes the measurement process to image data while referring to the image variable described above.

According to the present embodiment, the content of the pickup command received from the main control section 11 is used in order to identify the camera from which the image data is obtained. However, it is possible to use an image capturing signal that is transmitted from the image input section 16 to the cameras 30a to 30c. In this case, the image capturing signal can be temporary cached in the work memory of the image input section 16. Further, the image pickup trigger signal from the PLC 60 can also be used as described in “Outline of Configuration” instead of the pickup command or the image capturing signal.

Further, according to the present embodiment, substitution of the image data with the image variable that is previously prepared in the image memory 17a is considered as the assignment process for the measurement process to the image data. However, other various methods can be considered. For example, using a pointer of the C language, the image data can indicate a stored sequence element as the image variable. Alternatively, the image data can be substituted with the image variable that corresponds to the camera from the beginning when the image data obtained from the cameras 30a to 30c is buffered in the image memory 17a. In this case, the camera from which the image data is obtained is identified using the image variable, and the internal transfer to the image memory 17b can be the assignment process for the measurement process to the image data.

The image processor 18 reads the image data stored in the image memory 17b and executes the measurement process. The image data to which the measurement process is executed can be identical with the image data stored in the image memory 17a, or can be image data to which pre-processing (such as noise reduction) have been executed in the image input section 16 or the image processor 18.

The image display section 19 displays a predetermined image on the monitor 40 based on a display command transmitted from the main control section 11. For example, the image display section 19 reads the image data before or after the measurement process stored in the image memory 17b, temporarily stores (expands) in the video memory 20, and transmits the image data display signal to the monitor 40.

### Flow of Image Processing

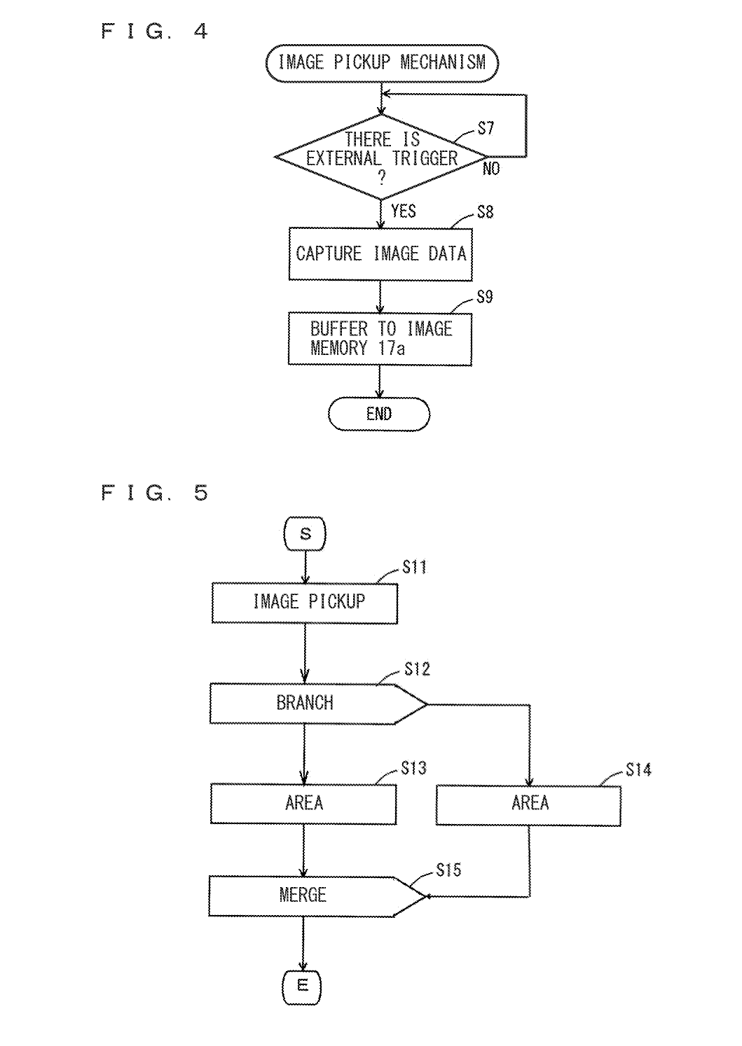

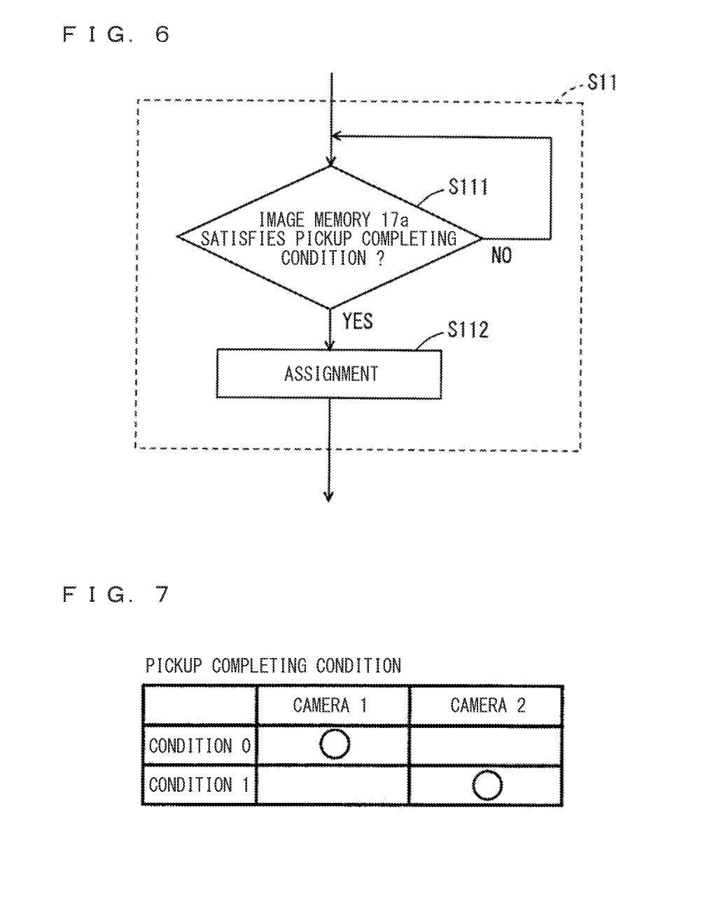

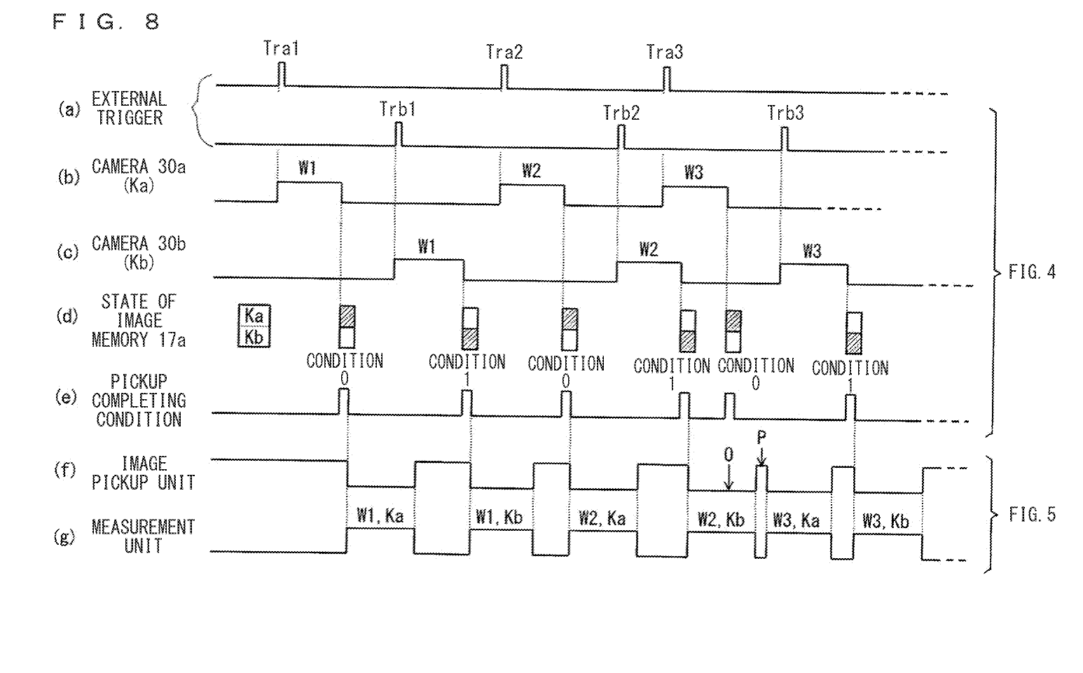

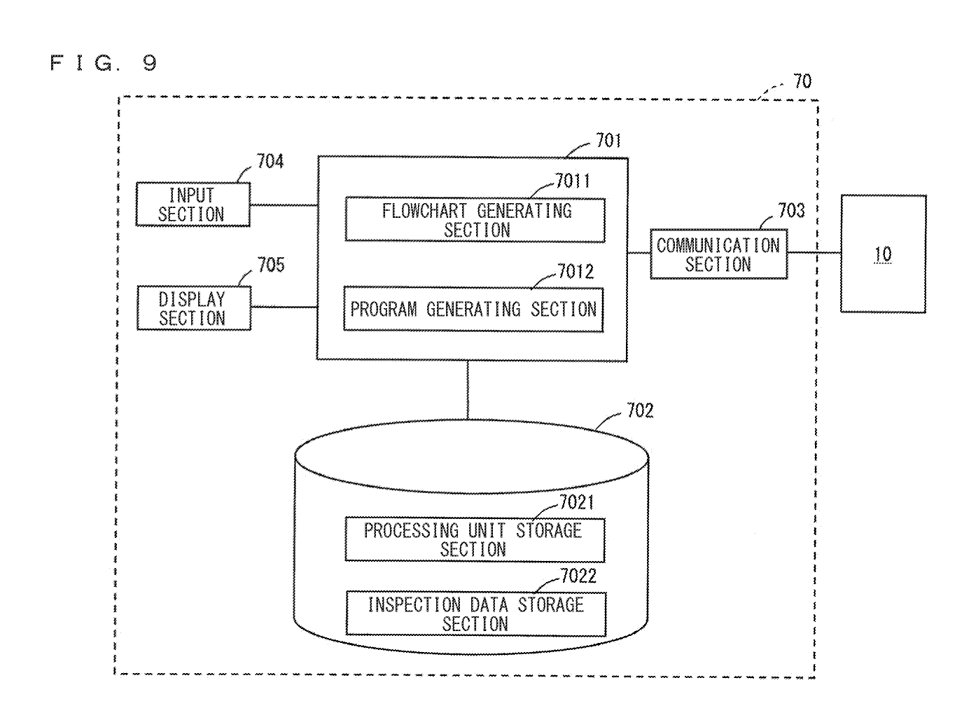

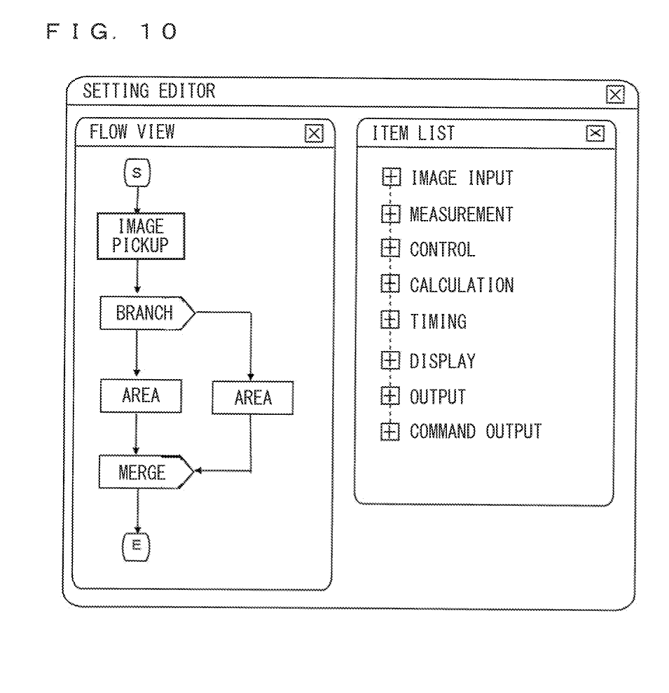

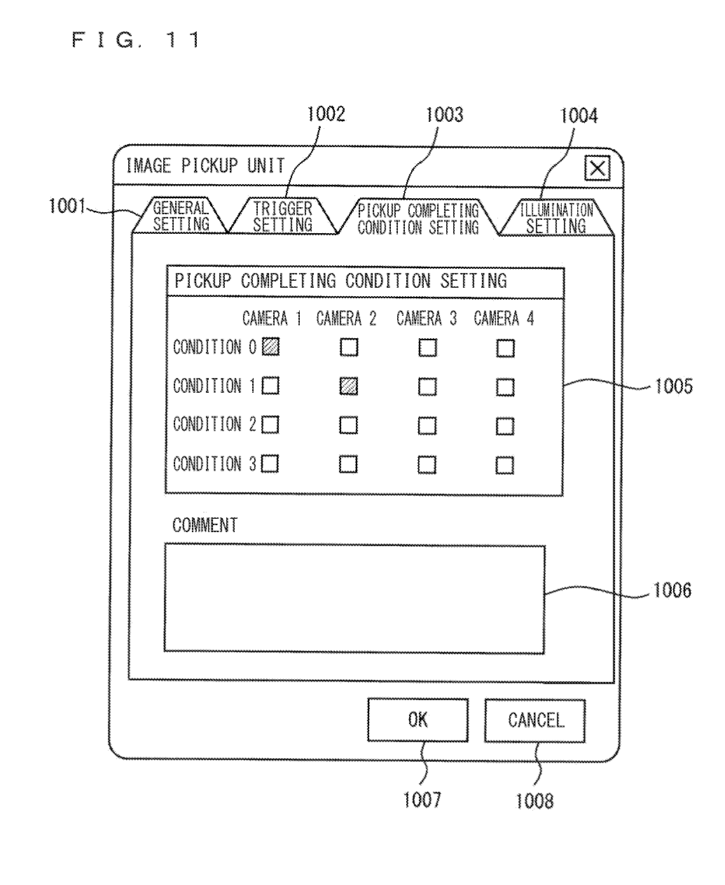

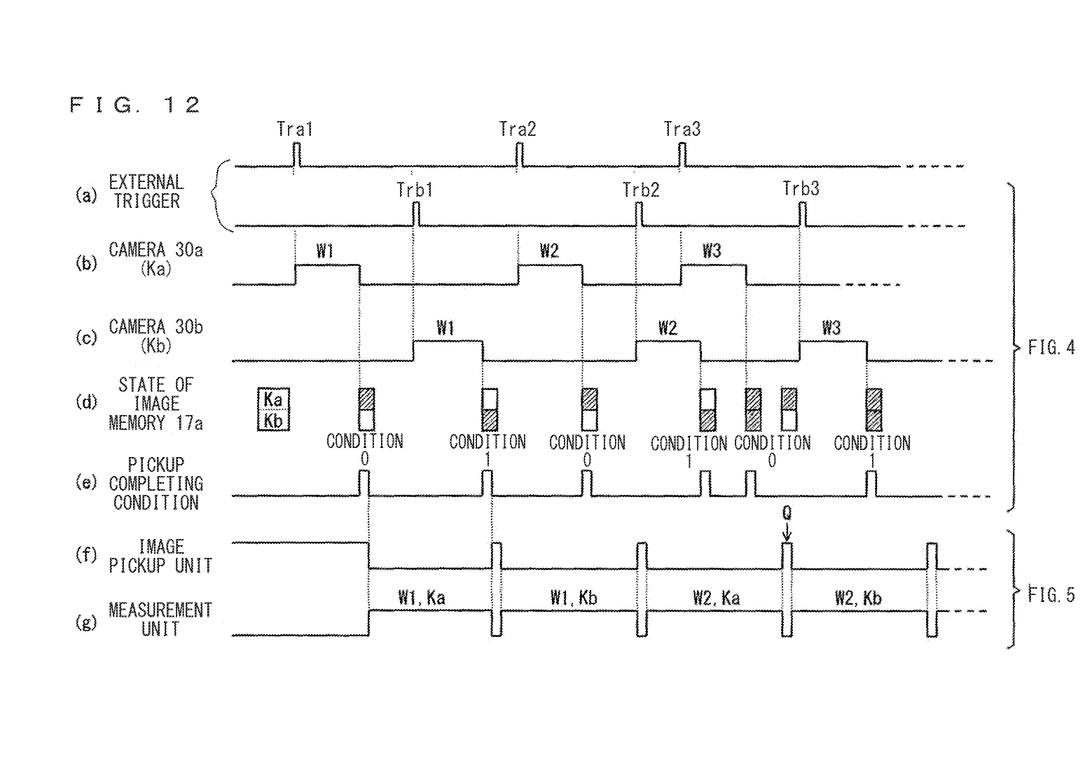

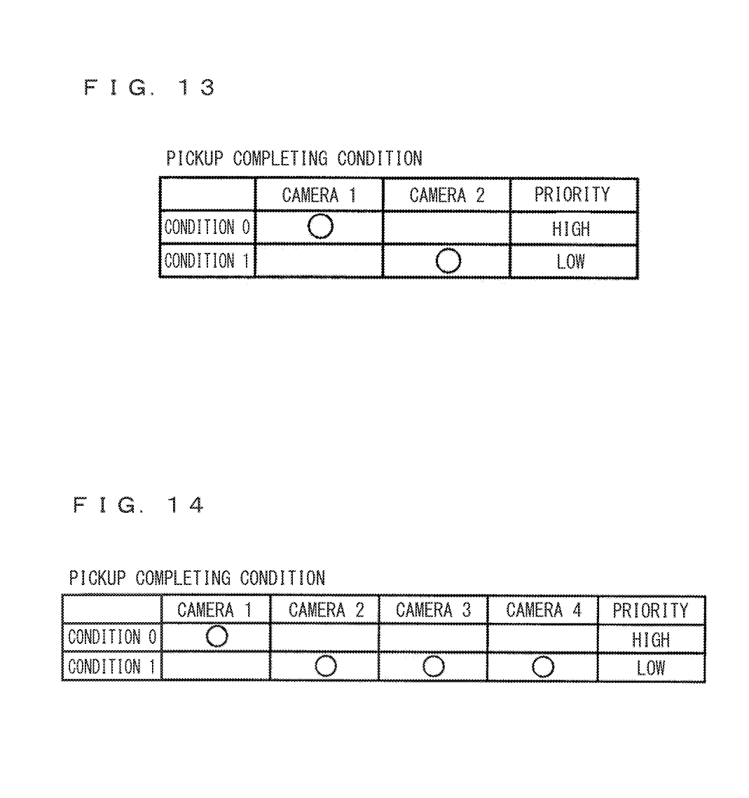

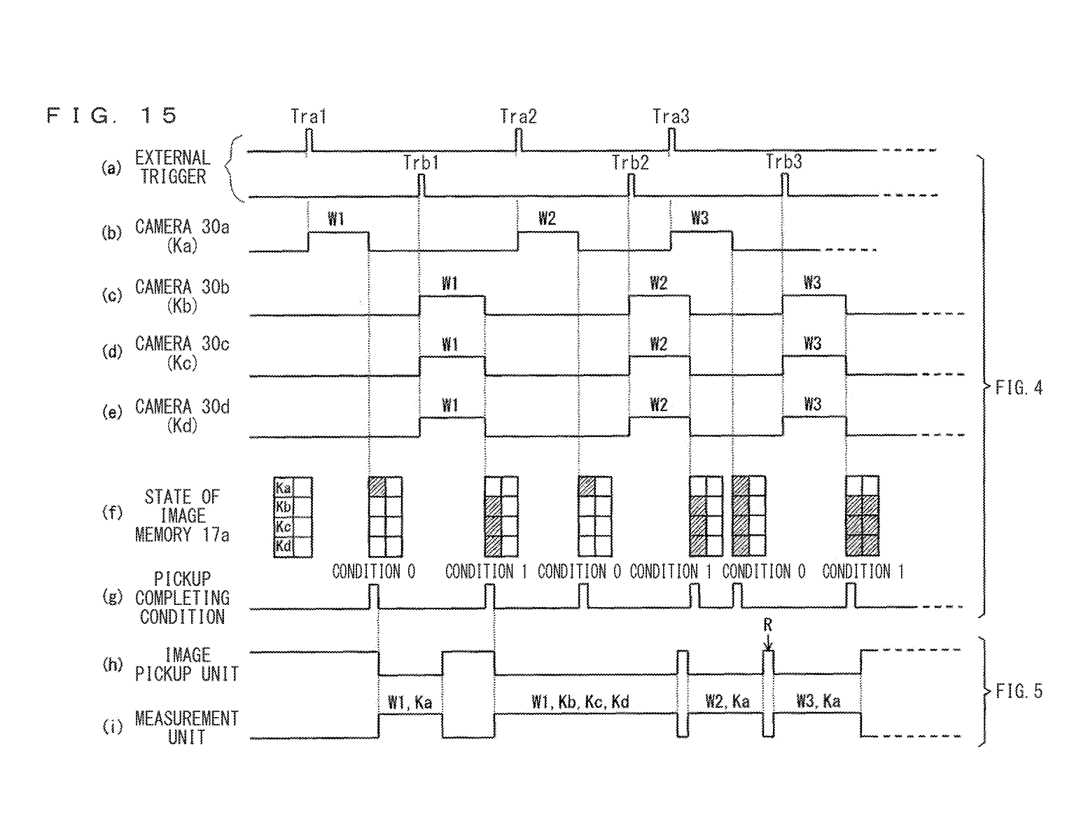

FIG. 4 is a flowchart showing an operation of the image pickup mechanism in the image processing device 1 according to the present embodiment. As used herein, the “image pickup mechanism” refers to, as described with reference to FIGS. 2A and 2B, a mechanism that (repeatedly) obtains the image data from the cameras 30a to 30c asynchronously with predetermined procedures.

Referring to FIG. 4, first, it is determined whether or not there is an external trigger input (step S7). Specifically, the main control section 11 determines whether the image pickup trigger signal has been received from the PLC 60 via the communication section 14. If it is determined that the signal has not been received yet (step S7: NO), the main control section 11 stands by until the reception. On the other hand, if it is determined that the signal has been received (step S7: YES), the main control section 11 transmits the pickup command to the image input section 16. In this manner, as described above, the image input section 16 captures the image data (step S8) and buffers the image data to the image memory 17a (step S9). The capturing of the image data and the buffering to the image memory 17a are repeatedly carried out triggered by the external trigger input. Accordingly, it is possible to eliminate the image pickup inhibit period provided to prevent the incomplete image pickup.

FIG. 5 is a flowchart showing one example of the procedures for controlling the image processing device 1 according to the present embodiment. The flowchart shown in FIG. 5 determines the measurement cycle taking a flow sequence from the START symbol (in this case, indicated by 5) to the END symbol (in this case, indicated by E) as image processing of a single cycle, constituted by an image pickup unit (step S11), a branch unit that branches the process flow into two or more branch flows (step S12), area units for carrying out area calculation as one example of the measurement unit (step S13 and step S14), and a merge unit for merging the branch flows that have been branched (step S15). These processing units are symbols respectively representing processes in which parameters can be altered, and provided on the flowchart with the PC 70. In the description below, only the cameras 30a and 30b are used out of the cameras 30a to 30c for the sake of description.

Referring to FIG. 5, first, the image pickup unit is executed (step S11). When the image pickup unit is being executed, the camera from which the image data obtained by the image pickup mechanism (FIG. 4) is obtained out of the camera 30a and the camera 30b is identified by the image input section 16. Then, it is determined which one of the pickup completing conditions of the plurality of types is established by the image input section 16 based on a result of the identification, and the assignment process for the measurement process to the image data used for the execution of the area unit associated with the pickup completing condition that is determined to be established (step S13 or step S14) is executed. Subsequently, via the branch unit (step S12), either the area unit of step S13 or the area unit of step S14 is executed.

The image pickup unit of step S11 is further described in detail with reference to FIG. 6. FIG. 6 is a flowchart showing the process flow of the image pickup unit (step S11) shown in FIG. 5. As shown in FIG. 6, in the present embodiment, it is determined whether or not the image memory 17a satisfies the pickup completing condition (step S111). Specifically, the image input section 16 accesses the main memory 13, refers to the previously set pickup completing conditions, and determines whether the pickup completing conditions are established based on the pickup command received from the main control section 11.

For example, FIG. 7 is a diagram showing one example of the pickup completing conditions. Referring to FIG. 7, it is set such that a condition 0 is established when the image data stored in the image memory 17a is obtained from the camera 30a, and a condition 1 is established when the image data is obtained from the camera 30b. According to the present embodiment, in step S111 shown in FIG. 6, it is determined whether the image memory 17a satisfies the pickup completing conditions (including two types of the condition 0 or the condition 1) shown in FIG. 7.

If it is determined that the pickup completing conditions are not satisfied (step S111: NO), that is, if it is determined that the image memory 17a does not store either the image data obtained from the camera 30a or the image data obtained from the camera 30b, the image input section 16 stands by until the pickup completing condition is satisfied. On the other hand, if it is determined that the pickup completing condition is satisfied (step S111: YES), that is, if it is determined that the image memory 17a stores either the image data obtained from the camera 30a or the image data obtained from the camera 30b, the image input section 16 carries out the assignment process for the measurement process (step S112). Specifically, the image input section 16 substitutes the image data buffered in the image memory 17a with the image variable that has previously been prepared for the measurement process. When the assignment process for the measurement process ends, the execution of the image pickup unit in step S11 is completed. The determination process in step S111 can be carried out continuously while the image pickup unit is being executed, or the determination process in step S111 can be carried out at periodical intervals.

Referring back to FIG. 5, after the execution of the image pickup unit in step S11 is completed, the process of the branch unit is executed (step S12). Specifically, according to the present embodiment, in the properties of the branch unit, the condition 0 shown in FIG. 7 is associated with the area unit of step S13 shown in FIG. 5, and the condition 1 shown in FIG. 7 is associated with the area unit of step S14 shown in FIG. 5. Therefore, when it is determined that the condition 0 among the pickup completing conditions shown in FIG. 7 is established, the area unit of step S13 shown in FIG. 5 is executed, and when it is determined that the condition 1 among the pickup completing conditions shown in FIG. 7 is established, the area unit of step S14 shown in FIG. 5 is executed.

When either the area unit of step S13 or the area unit of step S14 is executed, the image input section 16 internally transfers the image data substituted with the image variable from the image memory 17a to the image memory 17b. The image processor 18 reads the image data from the image memory 17b, and executes the measurement process such as edge detection and area calculation. At this time, by referring to the image variable with which the image data is substituted, it is recognized whether the measurement process is executed to the image data obtained from the camera 30a or to the image data obtained from the camera 30b.

Finally, the single flow sequence is completed at the END symbol after the merge unit (step S15). The content to be executed by the area unit of step S13 and the area unit of step S14 can be either the same or different.

As described above, in the controller 10 of the image processing device 1, the image of the test object is picked up asynchronously by the image pickup mechanism that operates in the background of the flowchart shown in FIG. 5 (FIG. 4), it is determined which one of the pickup completing conditions of the plurality of types is established by the image pickup unit (step S11) of the flowchart shown in FIG. 5, and the assignment process for the measurement process is executed to the image data used for the execution of the measurement unit associated with the pickup completing condition that is determined to be established. Specifically, it is possible to execute the image pickup unit (step S11) and the area unit (step S13 or step S14) in synchronization with the flowchart shown in FIG. 5. Therefore, it is possible to eliminate the image pickup inhibit period provided to prevent the incomplete image pickup, and to prevent the problems of memory contention and bug fix that can occur when the image pickup unit or the area unit is executed asynchronously.

### Timing Chart

The image processing described with reference to FIGS. 4 to 7 is now described chronologically with reference to timing charts. FIG. 8 shows a timing chart (conceptual diagram) showing the flow of the image processing in the image processing device 1 according to the present embodiment. In FIG. 8, (a) shows timings for inputting the external trigger such as the image pickup trigger signal, (b) shows periods for processing of the image pickup using the camera 30a (step S8 in FIG. 4) and the buffering (step S9 in FIG. 4), (c) shows periods for processing of the image pickup using the camera 30b (step S8 in FIG. 4) and the buffering (step S9 in FIG. 4), (d) shows a storing state of the image memory 17a (in (d) in FIG. 8, an upper half is shaded when image data Ka obtained from the camera 30a is stored, and a lower half is shaded when image data Kb obtained from the camera 30b is stored), (e) shows timings at which the state of the image memory 17a becomes storing state that satisfies the pickup completing condition, (f) shows periods during which the image pickup unit (step S11 in FIG. 5) is being executed (execution period), and (g) shows timings for executing the processing from the branch unit (step S12 in FIG. 5) to merge unit (step S15 in FIG. 5) (execution period).

For (a) in FIG. 8, an upper side shows the input timings of the external trigger to the camera 30a and a lower side shows the input timings of the external trigger to the camera 30b. Further, (g) in FIG. 8 is indicated as the “measurement unit” as it mainly shows the execution periods of the measurement units (the area units of step S13 and step S14 in FIG. 5). Moreover, the timing chart from (a) to (e) in FIG. 8 correspond to the flowchart shown in FIG. 4, and the timing chart of (f) in FIG. 8 and (g) in FIG. 8 correspond to the flowchart shown in FIG. 5.

Further, FIG. 8 only shows a conceptual diagram, and it is possible to change time duration of each pulse and timings of a leading edge/trailing edge accordingly. For example, unlike FIG. 8, it is possible to set the time duration of a pulse of each external trigger to be closer to 0 without limit, or the image pickup by the camera 30a or the camera 30b can be carry out at the timing of the trailing edge of a pulse.

As shown in (a) in FIG. 8, first, when an external trigger Tra1 is inputted to the camera 30a, picking up of the image of the test object (workpiece W1) is carried out by the camera 30a. As described above, (b) in FIG. 8 shows the periods during which capturing of the image data Ka obtained by the image pickup by the camera 30a and buffering to the image memory 17a by the image input section 16 are being carried out. Further, in (b) in FIG. 8, the symbol W1 represents a first workpiece, a symbol W2 represents a subsequent workpiece, and a symbol W3 represents a further subsequent workpiece.

When the buffering to the image memory 17a ends, as shown in (d) in FIG. 8, the image data Ka obtained from the camera 30a is stored in the image memory 17a. At this time, as the image memory 17a is in the storing state that satisfies the “condition 0” out of the pickup completing conditions (see FIG. 7) ((e) in FIG. 8), the image input section 16 determines that the pickup completing condition is established, and the image input section 16 executes the assignment process for the measurement process. Specifically, the image data Ka obtained from the camera 30a is substituted with the image variable that is previously prepared for the measurement process.

Thereafter, the image data Ka substituted with the image variable is internally transferred to the image memory 17b, and the area unit (step S13 shown in FIG. 5) is executed to the image data Ka. In (g) in FIG. 8, (W1, Ka) represents that the area unit is executed to the obtained image data Ka as a result of the picking up the image of the workpiece W1 by the camera 30a.

The same also applies when an external trigger Trb1, Tra2, or Trb2 is inputted. The process sequentially moves from the input of the external trigger Trb1, to the image pickup by the camera 30b, to the capturing of the image data Kb, to the buffering to the image memory 17a, to the image pickup unit, and finally to the measurement unit (W1, Kb). The process sequentially moves from the input of the external trigger Tra2, to the image pickup by the camera 30a, to the capturing of the image data Ka, to the buffering to the image memory 17a, to the image pickup unit, and finally to the measurement unit (W2, Ka). The process sequentially moves from the input of the external trigger Trb2, to the image pickup by the camera 30b, to the capturing of the image data Kb, to the buffering to the image memory, to the image pickup unit, and finally to the measurement unit (W2, Kb).

Here, it is assumed that the third workpiece W3 is carried under the camera 30a early. Specifically, it is assumed that an external trigger Tra3 is inputted before the capturing and buffering of the image data Kb obtained by the image pickup by the camera 30b end (see (a) in FIG. 8). In this case, the image data Ka of the workpiece W3 obtained by the image pickup by the camera 30a is captured (see (b) in FIG. 8), and this image data is temporarily buffered in the image memory 17a (see (d) in FIG. 8). Therefore, when the external trigger Tra3 is inputted, the image of the workpiece W3 can be picked up by the camera 30a without fail.

Further, when the image data Ka of the workpiece W3 obtained by the image pickup by the camera 30a is buffered by inputting the external trigger Tra3, the measurement unit of (W2, Kb) is executed (see an arrow O in (f) in FIG. 8). When the measurement unit of (W2, Kb) ends in the image processor 18, the image input section 16 moves to the next measurement cycle upon reception of the signal indicating that the process of the measurement unit ends from the image processor 18. Along with this, the image pickup unit in the next measurement cycle is executed (see an arrow P in (f) in FIG. 8). Then, in this image pickup unit, as described above, whether or not the image memory 17a satisfies the pickup completing conditions shown in FIG. 7 is determined by the image input section 16, and as it is determined that “the condition 0” is satisfied out of the pickup completing conditions, the assignment process for the measurement process is executed.

Subsequently, the process moves to the measurement unit shown in (g) in FIG. 8. Specifically, the internal transfer from the image memory 17a to the image memory 17b is carried out by the image input section 16, and the measurement process such as the area calculation is executed.

### Setting of Pickup Completing Condition

FIG. 9 is a block diagram showing a functional configuration of the PC 70 that generates the image processing program of the image processing device 1. FIG. 10 is a diagram showing one example of an editor screen (only the main portion) displayed in a display section 705 of the PC 70. FIG. 11 is a diagram showing one example of a setting screen for setting the pickup completing conditions shown in FIG. 7.

The PC 70 shown in FIG. 1 or 3 is constituted by a CPU, a ROM, a RAM, and the like, and is provided with a control section 701 that functions as a flowchart generating section 7011 and a program generating section 7012, a memory 702 that is constituted by a hard disk and the like and functions as a processing unit storage section 7021 and an inspection data storage section 7022, a communication section 703 that is connected to the controller 10 of the image processing device 1 so as to be able to communicate with each other, an input section 704 that is constituted by a mouse, a keyboard, and the like, and the display section 705 that is constituted by a liquid crystal monitor and the like.

The flowchart generating section 7011 has a function to generate a flowchart that starts from a START symbol and ends at the END symbol by providing the image processing units along the execution flow. Specifically, by operating the input section 704, when a desired image processing unit is dragged from an item list in the editor screen (right side) shown in FIG. 10 and dropped to a desired position in a flow view window (left side), the flowchart generating section 7011 provides this image processing unit at this position.

Each image processing unit is read from the processing unit storage section 7021. As shown in FIG. 10, the plurality of image processing units are displayed in the item list, and divided into categories including “image input”, “measurement”, “control”, “calculation”, “timing”, “display”, “output”, and “command output”. The “image input” is a category to which an image processing unit relating to the image pickup belongs, and the image pickup unit (step S11 in FIG. 5) described above belongs to this category. The image pickup unit is associated with parameters such as the properties for setting a shutter speed, camera sensitivity, flash on time, flash delay time, a camera for picking up, and a trigger terminal. In particular, as will be described later with reference to FIG. 11, in the image processing device 1 according to the present embodiment, parameters for setting the pickup completing conditions are associated as the properties.

Further, the “measurement” is a category to which an image processing unit relating to the measurement belongs, and the measurement units that extract a measurement result from the image data obtained by the image pickup unit and determine whether the test object is good or defective based on the measurement result belong to this category. For example, the area units as described above (step S13 and step S14 in FIG. 5), the edge position detection unit, and the color inspection unit belong to this category. The “control” is a category to which an image processing unit relating to the control belongs, and the control units such as a bypass unit and the END symbol belong to this category. The bypass unit is the image processing unit constituted by the branch unit that branches the execution flow into two or more branch flows and the merge unit that merges the branch flows that have been branched based on the predetermined condition. The END symbol is the symbol at which a single flow sequence ends. The “calculation” is a category to which an image processing unit relating to the calculation such as numeric calculation unit belongs, the “timing” is a category to which an image processing unit relating to the timing control after the flow transition such as a timer waiting unit belongs, the “display” is a category to which an image processing unit relating to the display belongs, and the “output” and the “command output” respectively are categories to which image processing units relating to the output and command output belong.

Referring back to FIG. 9, the program generating section 7012 has a function of converting the flowchart that the user has created in the flow view window shown in FIG. 10 into setting data that the controller 10 can read to generate inspection data. The generated inspection data (image processing program) is stored in the inspection data storage section 7022 of the memory 702. The control section 701 reads the inspection data from the inspection data storage section 7022, and transfers the inspection data to the controller 10 via the communication section 703.

As described above, the flow view window shown in FIG. 10 is a window for presenting the flowchart showing the procedures in order to newly create the image processing program of the controller 10 or to edit the image processing program obtained from the controller 10. The user is able to easily create a desired image processing program by placing image processing units along an execution flow starting from the START symbol and ending at the END symbol. Specifically, a series of the image processing that is carried out by the controller 10 is blocked into an image processing unit, and it is possible for the user to, by simply placing an image processing unit along an execution flow, create a flow sequence in which the image processing unit carries out a predetermined process based on the processing result of the immediately previous image processing unit.

Here, in the flow view window shown in FIG. 10, by clicking the right mouse button with the cursor pointing to the image pickup unit (operating the input section 704), an edit screen for setting the properties shown in FIG. 11 is displayed in the display section 705. Alternatively, the setting editor screen is provided with a unit property window (not shown), and properties of the image processing unit that is selected in the flow view window and displayed with focus are displayed in the unit property window. Then, the pickup completing conditions of the plurality of types are set in the edit screen shown in FIG. 11.

As shown in FIG. 11, at an upper part of the setting screen, there are provided a general setting tab 1001 for carrying out general setting relating to the image pickup, a trigger setting tab 1002 for carrying out setting relating to whether or not the input timings of the external triggers are synchronized (alternatively along with a certain delay time), an illumination setting tab 1004 for carrying out illumination setting when carrying out the image pickup, and a pickup completing condition setting tab 1003 that is currently being selected.

When the pickup completing condition setting tab 1003 is selected, a pickup completing condition setting table 1005, a comment area 1006, an OK button 1007, and a cancellation button 1008 appears. The user sets the pickup completing condition using the input section 704 of the PC 70, for example, by marking a checkbox above the pickup completing condition setting table 1005. Assuming a case in which four cameras are connected, the pickup completing condition setting table 1005 includes four columns for a camera 1 to a camera 4 and four rows for the condition 0 to a condition 3 so that four conditions can be set. According to the present embodiment, the camera 1 and the camera 2 respectively correspond to the camera 30a and the camera 30b that are actually used. In order to set the pickup completing conditions as shown in FIG. 7, the camera 30a is selected for the condition 0, and the camera 30b is selected for the condition 1.

Finally, the setting of the pickup completing conditions is completed by pressing the OK button 1007. As described above, in the image processing device 1 according to the present embodiment, it is possible to set each of the pickup completing conditions of the plurality of types to be established either when the image data is obtained from the camera 30a (camera 1) or when the image data is obtained from the camera 30b (camera 2) (FIG. 11). Specifically, the user is able to set the contents of the pickup completing conditions of the plurality of types using the PC 70 or the console 50. Accordingly, it is possible to improve usability of the image processing device 1.

The same also applies when setting the properties for the branch unit (step S12 in FIG. 5). Specifically, although not particularly shown, an edit screen for setting the properties for the branch unit is displayed in the display section 705, and association between the pickup completing conditions and the measurement unit are made using the input section 704. Specifically, the image processing device 1 according to the present embodiment is configured such that the image processing units include the branch unit that executes the branching process for branching the procedures into the plurality of measurement units, and the image input section 16 make association between the pickup completing condition that is determined to be established and the measurement unit. As a result, it is possible to set the plurality of patterns of association between one or a plurality of types of the plurality of cameras and one of the plurality of measurement processes (association between the condition 0 and the camera 1, and association between the condition 1 and the camera 2).

Subsequently, the inspection data is generated based on the flowchart, and the inspection data is transferred to the controller 10. The main control section 11 stores the inspection data including the image processing program in the main memory 13, and enables the reference to the setting content of the pickup completing condition setting table 1005 by the image input section 16. Then, it is determined whether the pickup completing conditions are established or not by the image input section 16 referring accordingly to the setting content of the pickup completing condition setting table 1005. Although the setting content of the pickup completing condition setting table 1005 is stored in the main memory 13 according to the present embodiment, the setting content of the pickup completing condition setting table 1005 can be stored in the work memory in the image input section 16 or in the image memory 17a. Further, by using a nonvolatile memory such as an EEPROM, the pickup completing conditions can be set previously, for example, before shipment. In this manner, it is possible to save time and effort for the user to set the pickup completing conditions.

As described above, in the PC 70 that is connected to the image processing device 1 and that generates the inspection data (image processing program) for the image processing device 1, the flowchart including the image pickup units to which the plurality of pickup completing conditions (the condition 0 and the condition 1) are set by the user's operation is generated. Then, after the inspection data (image processing program) for the image processing device 1 is generated based on this flowchart, the image processing program is transferred to the image processing device 1. Subsequently, the main control section 11 sets the pickup completing conditions based on the image processing program such that the setting content of the pickup completing condition setting table 1005 can be referred by the image input section 16. The screen shown in FIG. 11 can be displayed on the monitor 40 of the image processing device 1, and the pickup completing conditions can be set by the main control section 11 based on the operation of the console 50 by the user.

### Variations

FIG. 12 shows a timing chart (conceptual diagram) showing the flow of the image processing of the image processing device 1 according to another embodiment of the present invention. In the timing chart shown in FIG. 12, it takes time to execute the measurement unit. Specifically, execution time of the measurement unit shown in (g) in FIG. 12 is longer than execution time shown in (g) in FIG. 8. This is assumed when carrying out a measurement process with a large calculation load, for example, such as elaborated pattern matching. In such a case, it is often determined that two or more pickup completing conditions are established at the same time by the image input section 16 due to protraction of the immediately previous measurement process.

Specifically, it is assumed that the image pickup unit is to be executed in the next measurement cycle (an arrow Q in (f) in FIG. 12, step S11 in FIG. 5) after the execution of the measurement unit of (W2, Ka) of (g) in FIG. 12 ends. At this time, the image input section 16 refers to the setting content of the pickup completing condition setting table 1005, and determines whether or not the pickup completing conditions shown in FIG. 7 are established, and both the condition 0 and the condition 1 are established as shown in (e) in FIG. 12. Therefore, in such a case, the image input section 16 cannot determine whether to carry out the assignment process for the measurement process to the image data obtained from the camera 30a, or to the image data obtained from the camera 30b. As a result, this is possibly led to an image processing error.

Accordingly, in the image processing device 1 according to the another embodiment of the present invention, when the plurality of pickup completing conditions are determined to be established out of the pickup completing conditions of the plurality of types, the image input section 16 executes the assignment process to the image data used for executing the measurement unit associated with one pickup completing condition based on previously specified priority (details will be described later). Further, a function as a detection unit for detecting a timing at which the pickup completing condition is established is provided so as to be able to use the pickup completing condition that is first established in the image memory 17a. Specifically, programs that realize the functions in the image input section 16 are stored in the program memory (not shown) in the image input section 16. In order to realize the function for detecting the timing, the established timing (such as time of establishment) can be stored in the work memory in the image input section 16, the image memory 17a, or the like using an external timer or external counter, a CPU built-in timer, or the like, for example.

After the execution of the measurement unit of (W2, Ka), the image input section 16 executes the image pickup unit in the next measurement cycle. At this time, in the image memory 17a, both the condition 1 and the condition 0 are established at the same time out of the pickup completing conditions at the timing of the arrow Q of (f) in FIG. 12. Therefore, the image processor 16 reads the timing at which the condition 1 has been established and the timing at which the condition 0 has been established from the work memory, and compares the both timings. Then, the image processor 16 determines the image data obtained from the camera 30b as an execution target of the measurement process using the condition 1 that is first established, and the assignment process for the measurement process (similarly to the case described above, the substitution with the image variable is executed) is carried out. As a result, the measurement unit of (W2, Kb) is executed.

As described above, by providing the image input section 16 with the function for executing the assignment process to the image data based on the previously specified priority and the function for detecting the timings at which the pickup completing conditions are established, it is possible to prevent an image processing error in which the target of the measurement process becomes unknown. Further, although the first established timing is used herein, the latest (last) established timing (that is, the condition 0 in the case of FIG. 12) can also be used. Moreover, the priority can be previously specified among the pickup completing conditions, for example (see FIG. 13).

FIG. 13 is a pickup completing condition setting table that is used for the image processing device 1 according to another embodiment of the present invention. A difference from the pickup completing condition setting table shown in FIG. 7 is that, an item for priority is provided in the rightmost column. There is often the case in which, for example, when the camera 1 (the camera 30a) is a camera for picking up an image of an identifier (such as a bar code) for identifying the type of the workpiece, and the camera 2 (the camera 30b) is a camera for picking up an image of a predetermined surface of the workpiece, it is desired to prioritize the image pickup by the camera 1 over the camera 2. In such a case, the priority of the condition 0 is set to be “high” and the priority of the condition 1 is set to be “low” by a pull-down menu or the like, for example, as shown on the rightmost column in FIG. 13. The priority can be set using, for example, the PC 70, or the monitor 40 and the console 50. The image input section 16 uses a condition with higher priority (the condition 0) when referring to the pickup completing condition setting table shown in FIG. 13. Accordingly, at the timing of the arrow Q of (f) in FIG. 12, the assignment process for the measurement process is executed to the image data obtained from the camera 30a. As a result, unlike the case shown in FIG. 12, the measurement unit of (W3, Ka) is executed instead of (W2, Kb). As described above, by prioritizing the pickup completing conditions, it is possible to rate levels of importance among the pickup completing conditions. Specifically, by using the pickup completing condition setting table shown in FIG. 13, it is possible to continue the process for identifying the image pickup unit from which the image data is obtained out of the plurality of image pickup units without executing the assignment process when it is determined that none of the pickup completing conditions of the plurality of types is established. When it is determined that one of the pickup completing conditions of the plurality of types is established, the assignment process can be executed to the image data used for executing the measurement unit associated with the pickup completing condition, and when it is determined that two or more of the pickup completing conditions of the plurality of types are established, the assignment process can be executed to the image data used for executing the measurement unit associated with one pickup completing condition based on the previously specified priority. Therefore, even when the pickup completing condition is not established or when two or more pickup completing conditions are established, it is possible to execute the image pickup unit and the measurement unit in synchronization with the predetermined procedures without making the content of the processing of the image pickup unit unclear.

FIG. 14 is a pickup completing condition setting table used for the image processing device 1 according to another embodiment of the present invention. A difference from the pickup completing setting table shown in FIG. 13 is that the pickup completing conditions are set for the four cameras (the camera 1 to the camera 4) connected to the controller 10. For example, the camera 1 (the camera 30a) is a camera for picking up an image of an identifier for identifying the type of the workpiece, and the camera 2 to the camera 4 (the camera 30b to a camera 30d) are cameras respectively for picking up images of an upper surface, a lower surface, and a side surface of the workpiece at the same time. Similarly to FIG. 12, the priority of the condition 0 is set to be “high” and the priority of the condition 1 is set to be “low”.

FIG. 15 shows a timing chart (conceptual diagram) showing the flow of the image processing using the pickup completing condition setting table shown in FIG. 14. As shown in (c) to (e) in FIG. 15, the pick up timings of the cameras 2 to 4 are the same time. Further, Trb1 to Trb3 represent input timings of the external triggers to the cameras 30b to 30d. Moreover, the storing state of the image memory 17a shown in (f) in FIG. 15 focuses only on the image data obtained from the camera 30a (Ka) to the camera 30d (Kd), and two screens are shown in the figure for each of the camera 30a (Ka) to the camera 30d (Kd). Furthermore, as shown in (i) in FIG. 15, processing time when executing the measurement unit to the image data obtained from the camera 2 to the camera 4 is longer than when executing the measurement unit to the image data obtained from the camera 1.

As shown in (h) and (i) in FIG. 15, after the measurement unit of (W2, Ka) ends, the image pickup unit process is executed in the next measurement cycle (see an arrow R in (h) in FIG. 15). At this time, the image input section 16 uses from a condition with higher priority (the condition 0) when referring to the setting content of the pickup completing condition setting table and determining whether or not the pickup completing conditions shown in FIG. 14 are established. Therefore, at the timing of the arrow R in (h) in FIG. 15, the assignment process for the measurement process is executed to the image data obtained from the camera 30a. As a result, the measurement unit of (W3, Ka) is executed.

When capturing of the image data by the cameras 30b to 30d (see (c) to (e) in FIG. 15) is carried out before the execution of the measurement unit of (W3, Ka) ends, the image memory 17a stores image data for two screens (see (f) in FIG. 15). Subsequently, for example, it is possible to execute the measurement unit in the order stored in the image memory 17a.

It is possible for the user to set the number of screens of the image data that can be stored in the image memory 17a. Specifically, the image processing device 1 can be provided with a capacity setting unit that sets capacity in a storage unit for storing the image data obtained by the image pickup by the image pickup unit. Therefore, it is possible to adjust an acceptable amount of the image data stockable by the image pickup mechanism, thus improving convenience of the image processing device 1.

Further, it is possible to obtain a state of the image memory 17a when additional image data cannot be stored in the image memory 17a. Specifically, it is possible to provide a notification unit that notifies the user when it is not possible to additionally store the image data obtained by the image pickup by the image pickup unit in the storage unit. As a mode of notification to the user, for example, it is conceivable that the monitor 40 displays an alarming display. In this manner, it is possible for the user to make a quick response by increasing an interval between workpieces that are being carried, or increasing the accessible amount using the capacity setting unit described above.

Alternatively, when the additional image data cannot be stored in the image memory 17a, it is possible to select between prohibiting the additional image pickup and overwriting. Specifically, it is possible to provide a selection unit that selects between prohibiting the subsequent image pickup by the image pickup unit and overwriting the image data that is already stored in the storage unit when it is not possible to store the image data additionally obtained by the image pickup by the image pickup unit in the storage unit. Accordingly, it is possible to determine whether or not the image pickup is prohibited according to the user's request, thus improving convenience of the image processing device 1.

The functions of the capacity setting unit, the notification unit, and the selection unit described above can be realized by the monitor 40 and the console 50, the main control section 11 and the image input section 16, or the like.

FIG. 16 is a pickup completing condition setting table used by the image processing device 1 according to another embodiment of the present invention. As shown in the pickup completing condition setting table in FIG. 16, the camera 1 and the camera 2 can be set for the condition 0 (the camera 1 and the camera 2 operate at the same time), the camera 3 can be set for the condition 1, and the camera 4 can be set for the condition 2.

FIG. 17 is a flowchart showing different procedures of the image processing of the image processing device 1 according to the present embodiment. In particular, the procedures using the pickup completing condition setting table shown in FIG. 16 will be described.

The pickup completing condition setting table as properties of an image pickup unit (step S21) shown in FIG. 17 is as shown in FIG. 16. Further, as the properties of a branch unit (step S22), the condition 0 is associated with an area unit of step S23 and a color inspection unit of step S24, and the rest of the conditions (the condition 1 and the condition 2) are associated with the other measurement unit. Moreover, as the properties of a branch unit (step S26), the condition 1 is associated with a numeric calculation unit of step S27, and the rest of the conditions (condition 2) is associated with an edge position detection unit of step S29. As described above, in the properties of the branch unit, the pickup completing conditions are respectively associated with the measurement units provided on the downstream side of the image pickup unit.

There can be various modes of the association as long as the process flow to be moved on can be recognized. Accordingly, for example, as the properties of the branch unit (step S22), the condition 0 is not necessarily required to be associated with the area unit of step S23 and the color inspection unit of step S24, and the condition 0 may be associated only with the area unit of step S23. It is possible to recognize the process flow to be moved on with such an association. Furthermore, for example, as the properties of the branch unit (step S22), association can be made with any of the measurement units that are provided on the downstream side. It is possible to recognize the process flow to be moved on even with such an association.

In the flowchart described above, when the image data from the camera 1 and the camera 2 is buffered in the image memory 17a, after the assignment process for the measurement process is carried out, the area unit (step S23) and the color inspection unit (step S24) are executed after step S21 and step S22. Further, when the image data from the camera 3 is buffered in the image memory 17a, after the assignment process for the measurement process is carried out, the numeric calculation unit (step S27) is executed after step S21, step S22, and step S26. Moreover, when the image data from the camera 4 is buffered in the image memory 17a, after the assignment process for the measurement process is carried out, the edge position detection unit (step S29) is executed after step S21, step S22, and step S26.

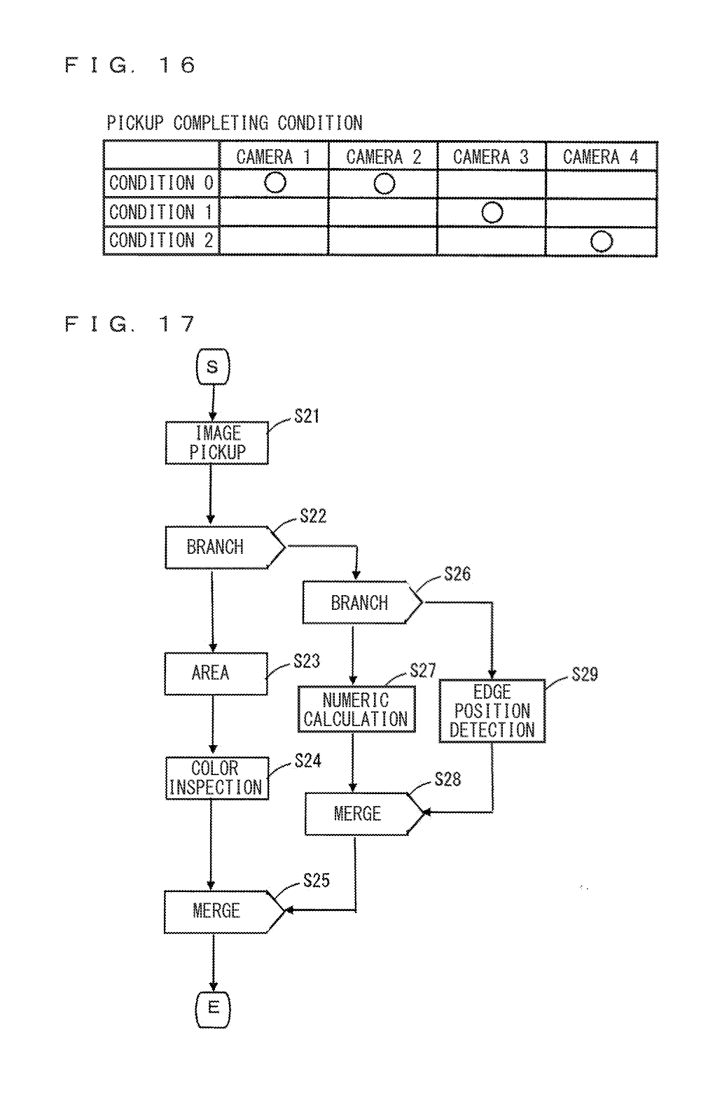

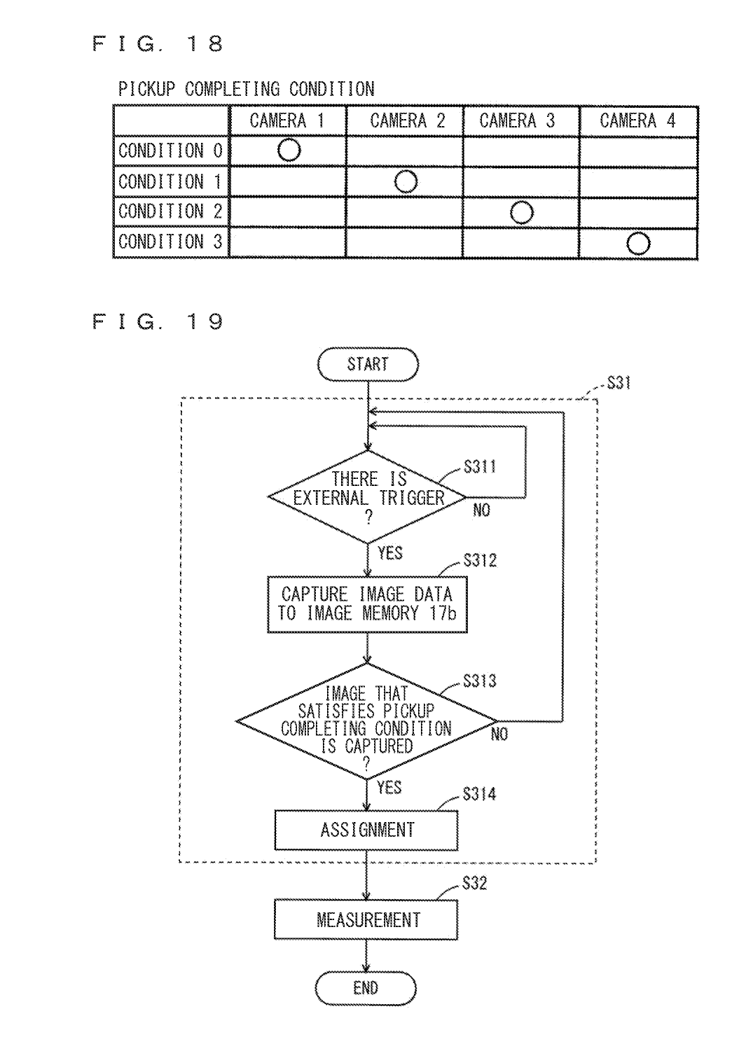

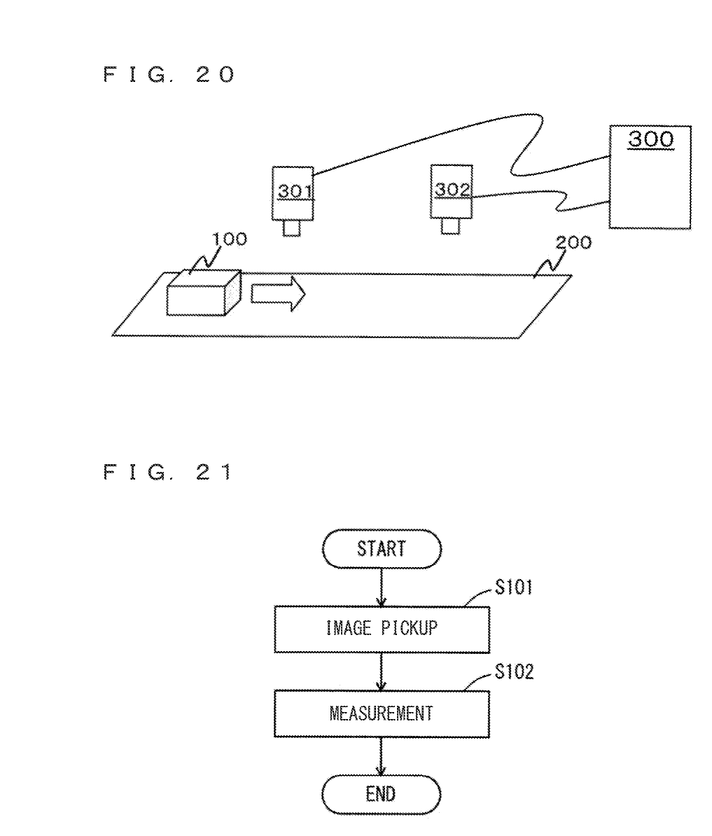

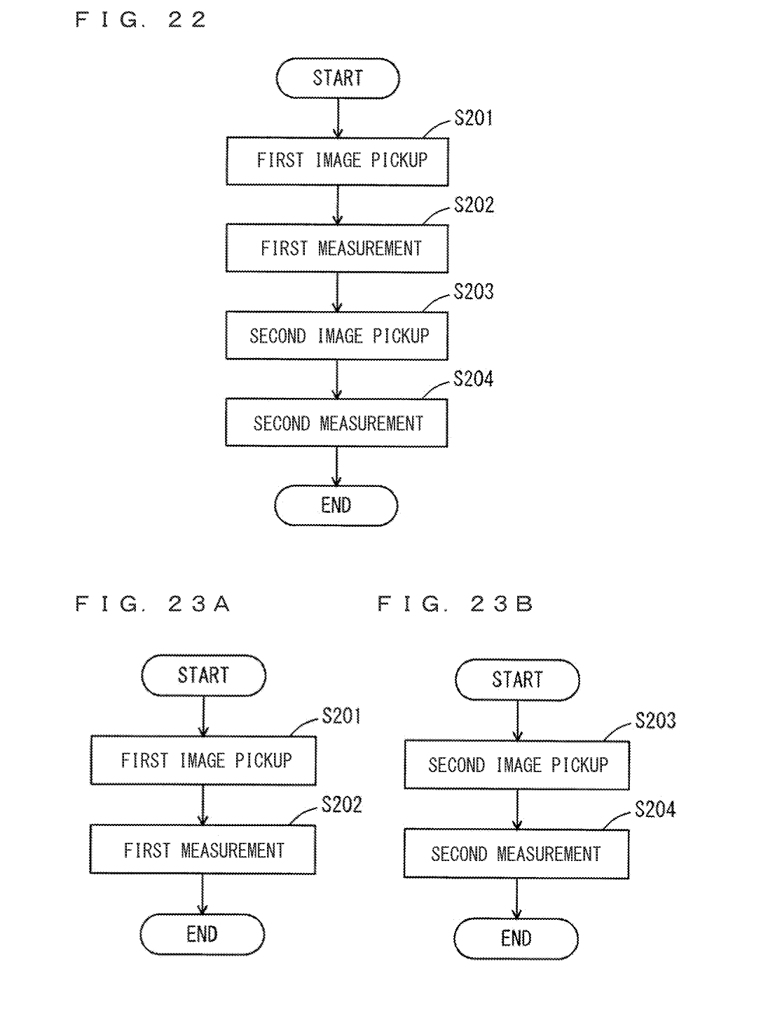

In FIG. 17, the two branch units and the two merge units are used. However, a single branch unit and a single merge unit may also be used. Specifically, it is possible to provide three branches by combining the branch units of step S22 and step S26 into a single branch unit, and by combining the merge units of step S25 and step S28 into a single merge unit. In addition, as shown in the pickup completing condition setting table of FIG. 18, it is possible set the camera 1 for the condition 0, the camera 2 for the condition 1, the camera 3 for the condition 2, and the camera 4 for the condition 3.

FIG. 19 is a flowchart showing a main flow of the image processing of the image processing device 1 according to another embodiment of the present invention. In the image processing as previously described, the image pickup mechanism shown in FIG. 4 is separately provided and asynchronously operated. However, as shown in FIG. 19, it is possible to incorporate the image pickup mechanism shown in FIG. 4 to be operated serially in the image pickup unit.

The image processing shown in FIG. 19 is roughly divided into an image pickup unit (step S31, see within a frame with dotted line) and a measurement unit (step S32). The measurement unit of step S32 is, similarly to FIG. 5, can be configured as the branch unit, the area unit, and the merge unit (step S12 to step S14).

In the image pickup unit (step S31) shown in FIG. 19, first, it is determined whether or not there is an external trigger input (step S311). If there is no trigger input (step S311: NO), the process stands by until there is a trigger input. If there is a trigger input (step S311: YES), capturing of the image data is carried out (step S312). In this case, as the image memory 17a that functions as a buffer memory (frame buffer) is not provided, when there is a trigger input, internal transfer is carried out along with the capturing of the image data. At this time, identification information indicating the camera from which the internally transferred image data is obtained (for example, information of the pickup command or the like as described above) is internally transferred at the same time. It is also possible to store only the identification information in the work memory in the image processor 18.

Subsequently, it is determined whether the image that satisfies the pickup completing condition is captured by the image processor 18 instead of the image input section 16 (step S313). Specifically, the image processor 18 accesses the image memory 17b and refers to the identification information, thereby recognizing the camera from which the stored image data is obtained. At the same time, the image processor 18 accesses the main memory 13 and refers to the previously set pickup completing conditions, thereby determining whether or not the recognized image data satisfies the pickup completing conditions.

When it is determined that any of the pickup completing conditions is not satisfied (step S313: NO), the process returns to step S311, and when it is determined that any of the pickup completing condition is satisfied (step S313: YES), the assignment process for the measurement process is carried out (step S314). Specifically, similarly to the process in step S112 described above, the substitution with the image variable is carried out by the image processor 18. Finally, when the assignment process for the measurement process in step S314 ends, the process moves to the measurement unit (step S32).

As described above, the image pickup mechanism can be (serially) operated when the image pickup unit process is executed.

### Major Effect of Embodiments

As described above, according to the image processing device 1 of the embodiments of the present invention, it is possible to eliminate an image pickup inhibit period for preventing incomplete image pickup while sequentially storing the image data obtained from the cameras in the image memory 17a (the image memory 17b in the image processing shown in FIG. 19). As a result, it is possible to decrease the processing time for each camera as well as the inspection tact. Further, it is possible to execute the image pickup unit and the measurement unit in synchronization with the flowchart, in a manner that the pickup completing conditions of the plurality of types are set, and the process moves from one image pickup unit to the measurement unit that is associated with the pickup completing condition that is determined to be established by the image input section 16 out of the measurement units within the procedures. Therefore, it is possible to prevent the problems such as memory contention and bug fix that can occur when these units are executed asynchronously. Moreover, since only a single controller is needed, it is possible to reduce the user's cost.

What is claimed is:

1. An image processing device provided with a plurality of cameras that generate image data by picking up images of a test object, and configured to carry out measurement using the image data obtained from the plurality of cameras, output a determination signal by determining whether the test object is good or defective based on a result of the measurement, and execute an assignment process of carrying out assignment of the image data obtained from the plurality of cameras to be used in the measurement and a plurality of measurement processes of carrying out the measurement using the image data assigned in the assignment process, the device comprising:
a setting unit that sets a plurality of patterns of association between a type or types of one or more of the plurality of cameras and one of the plurality of measurement processes;
a determining unit that identifies a camera from which the image data is obtained out of the plurality of cameras, and determines whether or not the image data is obtained from a camera specified by one of the plurality of patterns of association set by the setting unit; and
an assigning unit that carries out assignment for executing one of the measurement processes that is specified by the pattern of association for which the image data is determined to have been obtained.

2. The image processing device according to claim 1, wherein
when the determining unit determines that the image data is not obtained, the assigning unit stands by without carrying out the assignment for executing the measurement process.

3. The image processing device according to claim 1, wherein
when the image data is determined to have been obtained from a camera of the type specified by two or more of the plurality of patterns of association set by the setting unit, the assigning unit carries out the assignment for executing the measurement process specified by one of the patterns of association based on predetermined priority.

4. The image processing device according to claim 3, wherein
the priority is determined based on a timing at which the image data is obtained by the camera of the type specified by one of the plurality of patterns of association that have been set by the setting unit.

5. An image processing method using an image processing device provided with a plurality of cameras that generate image data by picking up images of a test object, and configured to carry out measurement using the image data obtained from the plurality of cameras, output a determination signal by determining whether the test object is good or defective based on a result of the measurement, and execute an assignment process of carrying out assignment of the image data obtained from the plurality of cameras to be used in the measurement and a plurality of measurement processes of carrying out the measurement using the image data assigned in the assignment process, the method comprising:
a setting step of setting a plurality of patterns of association between a type or types of one or more of the plurality of cameras and one of the plurality of measurement processes;
a determining step of identifying a camera from which the image data is obtained out of the plurality of cameras, and determines whether or not the image data is obtained from a camera specified by one of the plurality of patterns of association set by the setting step; and
an assigning step of carrying out assignment for executing one of the measurement processes that is specified by the pattern of association for which the image data is determined to have been obtained.
